(19) United States
(12) Patent Application Publication
(10) Pub. No.: US 2026/0222593 A1
(43) Pub. Date: Jul. 30, 2026

(54) PLANAR HORIZONTAL, PLANAR VERTICAL MODE, AND PLANAR DIRECTIONAL MODE

(71) Applicant: InterDigital CE Patent Holdings, SAS, Paris (FR)

(72) Inventors: Ya Chen, Rennes (CA); Karam Naser, Mouazé (FR); Thierry Dumas, Rennes (FR); Gagan Bihari Rath, Rennes (FR)

(73) Assignee: InterDigital CE Patent Holdings, SAS, Paris (FR)

(21) Appl. No.: 19/141,540

(22) PCT Filed: Dec. 21, 2023
(86) PCT No.: PCT/EP2023/087416

§ 371 Date: Jun. 20, 2025

(30) Foreign Application Priority Data
Dec. 23, 2022 (EP) 22307021.0

(51) Int. Cl. H04N 19/159; H04N 19/105; H04N 19/132; H04N 19/176; H04N 19/186; H04N 19/593; H04N 19/70

(52) U.S. Cl. CPC H04N 19/159; H04N 19/105; H04N 19/132; H04N 19/176; H04N 19/186; H04N 19/593; H04N 19/70

(57) ABSTRACT

Systems, methods, and instrumentalities are disclosed for performing planar horizontal mode, planar vertical mode, and/or planar directional mode intra-prediction. Planar intra-prediction modes may be used in video coding for coding blocks. Directionality of planar intra-prediction modes may be used to determine a reference region and/or template. For example, a cross-component linear model (CCLM) or a multi-model linear model mode may be determined based on the direction of the planar mode. A reference region of chroma decoder-side intra mode derivation (DIMD) or convolutional cross-component model (CCCM) for a chroma block may be determined based on a planar mode associated with a collocated luma block. For example, a reference region or template for template-based intra mode derivation (TIMD) or spatial geometric partitioning mode (SGPM) may be determined based on the direction of the planar mode.

### CROSS-REFERENCE TO RELATED APPLICATIONS

The application claims the benefit of European Patent Application Number 22307021.0, filed Dec. 23, 2022, the contents of which are incorporated by reference in their entirety herein.

### BACKGROUND

Video coding systems may be used to compress digital video signals, e.g., to reduce the storage and/or transmission bandwidth needed for such signals. Video coding systems may include, for example, block-based, wavelet-based, and/or object-based systems.

### SUMMARY

Systems, methods, and instrumentalities are disclosed for performing planar horizontal mode, planar vertical mode, and/or planar directional mode intra-prediction. Planar intra-prediction modes may be used in video coding for coding blocks. Planar intra-prediction modes may be determined to be used based on indicated parameters, modes, neighboring blocks, gradients, templates, etc. Planar intra-prediction modes may be used to determine parameters. Directionality of planar intra-prediction modes may be used to determine a reference region and/or template. For example, a cross-component linear model (CCLM) or a multi-model linear model mode may be determined based on the direction of the planar mode. A reference region of chroma decoder-side intra mode derivation (DIMD) or convolutional cross-component model (CCCM) for a chroma block may be determined based on a planar mode associated with a collocated luma block. For example, a reference region or template for template-based intra mode derivation (TIMD) or spatial geometric partitioning mode (SGPM) may be determined based on the direction of the planar mode.

For example, a device (e.g., video encoder, video decoder) may determine a reference region and/or template for coding tools based on a direction of a determined planar mode (e.g., without explicit signaling). The device may determine a planar intra-prediction mode associated with a first coding block (e.g., first luma block, collocated luma block). A plurality of reconstructed neighboring samples may be identified, for example, based on the determined planar intra-prediction mode. For example, reconstructed neighboring samples may be associated with a left boundary of the second coding block if the planar intra-prediction mode is horizontal planar mode. For example, reconstructed neighboring samples may be associated with a top boundary of the second coding block if the planar intra-prediction mode is vertical planar mode The reconstructed neighboring samples may be associated with both a top boundary and a left boundary of the second coding block if the planar intra-prediction mode is conventional planar mode. A decoding and/or encoding function may be performed on a second coding block (e.g., a second luma block, a collocated chroma block) based on the identified reconstructed neighboring samples.

CCLM modes (e.g., CCLM_LT, CCLM_L and CCLM_T) and multi-model linear model (MMLM) modes (e.g., MMLM_LT, MMLM_L and MMLM_T) may be enabled for the chroma components. The CCLM and/or MMLM modes may be determined based on the direction of the planar mode (e.g., the planar mode of the collocated luma block). Those CCLM/MMLM modes may differ with respect to the locations of the reference samples that are used for model parameter derivation. Samples from the top boundary of the block (e.g., the block that comprises the collocated chroma block and luma block) may be involved in the CCLM_T/MMLM_T mode and samples from the left boundary may be involved in the CCLM_L/MMLM_L mode. In the CCLM_LT/MMLM_LT mode, samples from both the top boundary and the left boundary may be used.

Systems, methods, and instrumentalities described herein may involve a decoder. In some examples, the systems, methods, and instrumentalities described herein may involve an encoder. In some examples, the systems, methods, and instrumentalities described herein may involve a signal (e.g., from an encoder and/or received by a decoder). A computer-readable medium may include instructions for causing one or more processors to perform methods described herein. A computer program product may include instructions which, when the program is executed by one or more processors, may cause the one or more processors to carry out the methods described herein.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates an example video encoder.

FIG. 3 illustrates an example video decoder.

FIG. 4 illustrates an example of a a system in which various aspects and examples may be implemented.

FIG. 5 illustrates an example current block with neighboring reconstructed blocks.

FIG. 6 illustrates example angular intra prediction modes.

FIG. 7 illustrates Multiple reference line Intra prediction using reference lines.

FIG. 8 illustrates an example of intra-sub partition.

FIG. 9 illustrates an example use of decoder side intra mode derivation.

FIG. 10 illustrates an example of deriving intra prediction modes for decoder side intra mode derivation using a template.

FIG. 11 illustrates a coding unit and neighboring reconstructed samples for calculating the Sum of Absolute Transformed Differences.

FIG. 12A shows an example of a spatial geometric partitioning mode block partitioned according to one partition mode into two parts, each part being associated with an intra prediction mode.

FIG. 12B illustrates an example template for generating a candidate list.

FIG. 13 illustrates an example of reconstructing neighboring luma and chroma samples.

FIG. 14 illustrates example cross component linear model modes.

FIG. 15 illustrates an example of deriving a multi-model linear model.

FIG. 16A illustrates an example luma sample and collocated chroma samples.

FIG. 16B illustrates an example reference area which includes 6 lines of chroma samples above and left of the block.

FIG. 17 illustrates an example of using planar intra prediction.

FIG. 18 illustrates example signaling for indicating a planar mode to use.

FIG. 19 illustrates an example flow for determining a prediction mode.

FIG. 20A illustrates an example flow for determining an intra prediction mode.

FIG. 20B illustrates an example flow for determining an intra prediction mode.

FIG. 21 illustrates an example linear interpolation for a current block.

FIG. 22 illustrates an example flow for determining blending for planar predictor modes.

FIG. 23 illustrates an example flow of determining a planar predictor for blending.

FIG. 24 illustrates an example flow for determining a planar mode.

FIGS. 25A and 25B illustrate an example current block with neighboring blocks.

FIG. 26 illustrates an example flow for determining planar mode.

FIG. 27 illustrates an example of using chroma decoder side intra mode derivation.

FIG. 28 illustrates an example of using template-based intra mode derivation/spatial geometric partitioning mode.

FIG. 29 illustrates an example flow for applying planar modes to a luma block.

### DETAILED DESCRIPTION

A more detailed understanding may be had from the following description, given by way of example in conjunction with the accompanying drawings.

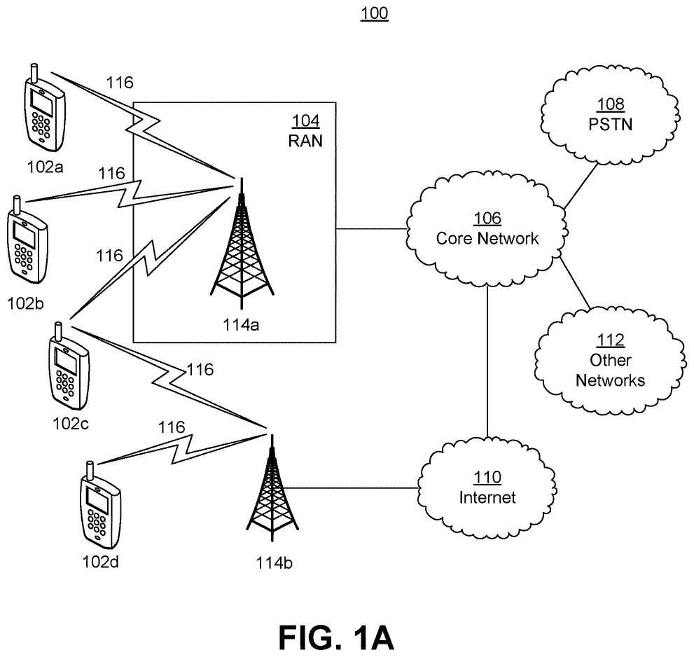

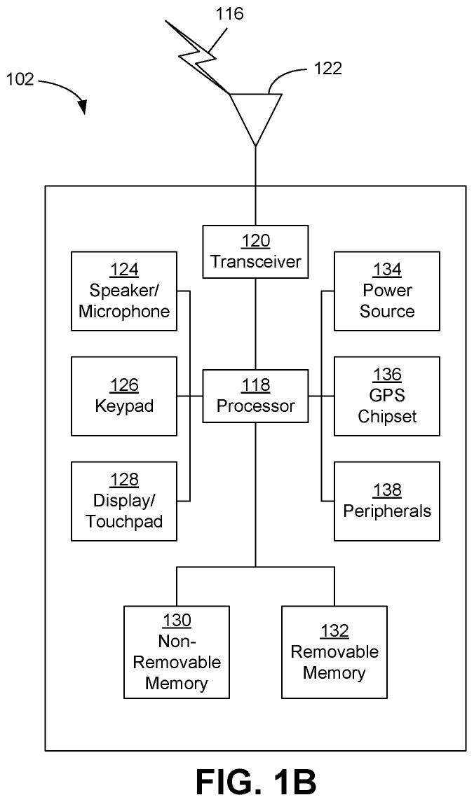

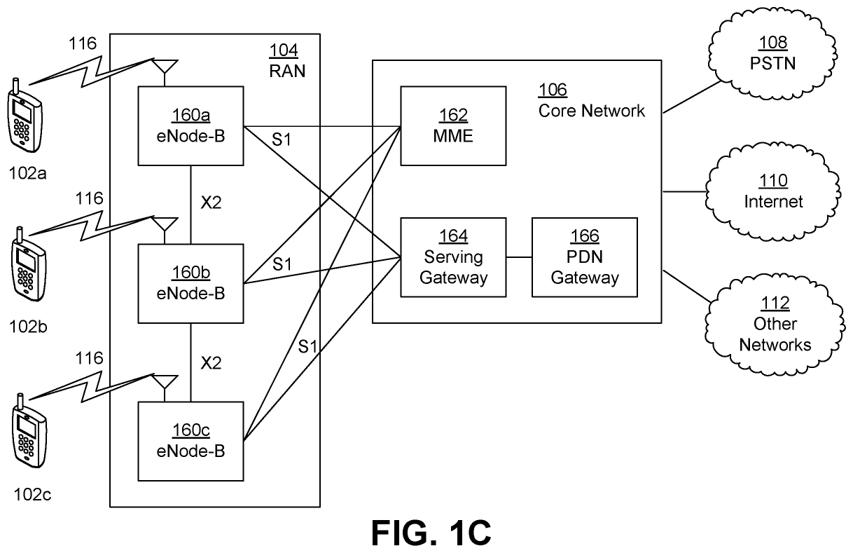

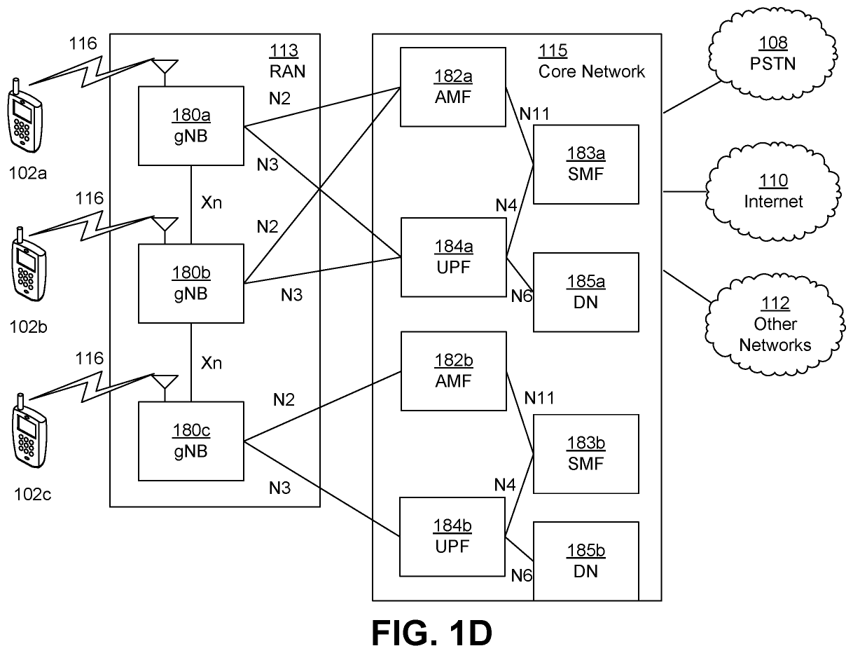

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

This application describes a variety of aspects, including tools, features, examples, models, approaches, etc. Many of these aspects are described with specificity and, at least to show the individual characteristics, are often described in a manner that may sound limiting. However, this is for purposes of clarity in description, and does not limit the application or scope of those aspects. Indeed, all of the different aspects may be combined and interchanged to provide further aspects. Moreover, the aspects may be combined and interchanged with aspects described in earlier filings as well.

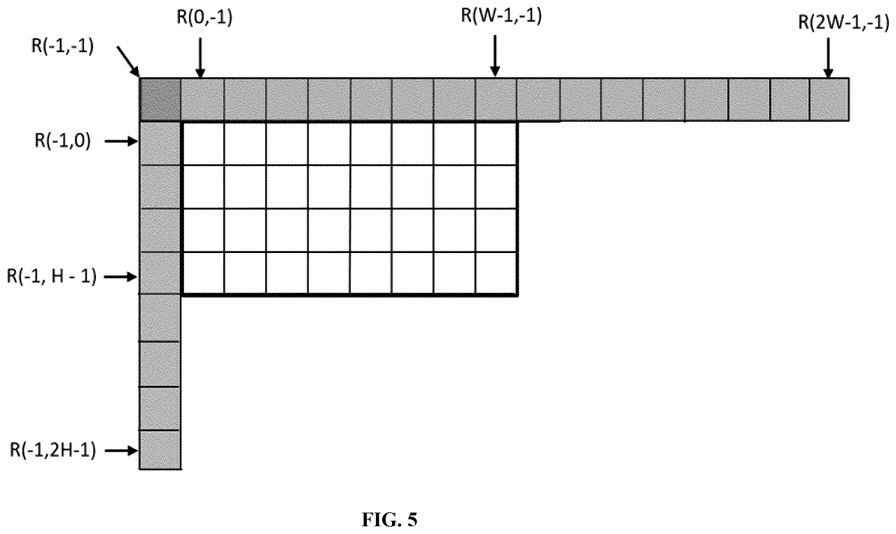

The aspects described and contemplated in this application may be implemented in many different forms. FIGS. 5-29 described herein may provide some examples, but other examples are contemplated. The discussion of FIGS. 5-29 does not limit the breadth of the implementations. At least one of the aspects generally relates to video encoding and decoding, and at least one other aspect generally relates to transmitting a bitstream generated or encoded. These and other aspects may be implemented as a method, an apparatus, a computer readable storage medium having stored thereon instructions for encoding or decoding video data according to any of the methods described, and/or a computer readable storage medium having stored thereon a bitstream generated according to any of the methods described.

In the present application, the terms “reconstructed” and “decoded” may be used interchangeably, the terms “pixel” and “sample” may be used interchangeably, the terms “image,” “picture” and “frame” may be used interchangeably.

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various examples to modify an element, component, step, operation, etc., such as, for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

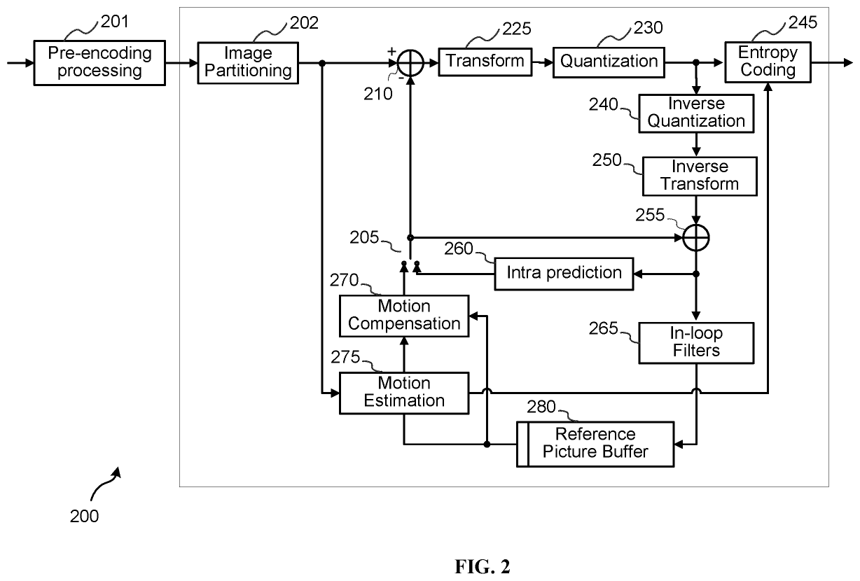

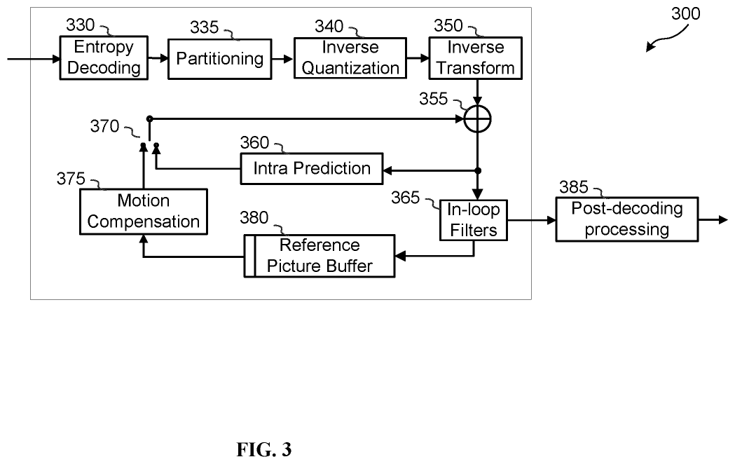

Various methods and other aspects described in this application may be used to modify modules, for example, decoding modules, of a video encoder 200 and decoder 300 as shown in FIG. 2 and FIG. 3. Moreover, the subject matter disclosed herein may be applied, for example, to any type, format or version of video coding, whether described in a standard or a recommendation, whether pre-existing or future-developed, and extensions of any such standards and recommendations. Unless indicated otherwise, or technically precluded, the aspects described in this application may be used individually or in combination.

Various numeric values are used in examples described the present application. These and other specific values are for purposes of describing examples and the aspects described are not limited to these specific values.

FIG. 2 is a diagram showing an example video encoder (e.g., block-based hybrid video encoder). Variations of example encoder 200 are contemplated, but the encoder 200 is described below for purposes of clarity without describing all expected variations.

Before being encoded, the video sequence may go through pre-encoding processing (201), for example, applying a color transform to the input color picture (e.g., conversion from RGB 4:4:4 to YCbCr 4:2:0), or performing a remapping of the input picture components in order to get a signal distribution more resilient to compression (for instance using a histogram equalization of one of the color components). Metadata may be associated with the pre-processing, and attached to the bitstream.

In the encoder 200, a picture is encoded by the encoder elements as described below. The picture to be encoded is partitioned (202) and processed in units of, for example, coding units (CUs). Each unit is encoded using, for example, either an intra or inter mode. When a unit is encoded in an intra mode, it performs intra prediction (260). In an inter mode, motion estimation (275) and compensation (270) are performed. The encoder decides (205) which one of the intra mode or inter mode to use for encoding the unit, and indicates the intra/inter decision by, for example, a prediction mode flag. Prediction residuals are calculated, for example, by subtracting (210) the predicted block from the original image block.

The prediction residuals are then transformed (225) and quantized (230). The quantized transform coefficients, as well as motion vectors and other syntax elements, are entropy coded (245) to output a bitstream. The encoder can skip the transform and apply quantization directly to the non-transformed residual signal. The encoder can bypass both transform and quantization, i.e., the residual is coded directly without the application of the transform or quantization processes.

The encoder decodes an encoded block to provide a reference for further predictions. The quantized transform coefficients are de-quantized (240) and inverse transformed (250) to decode prediction residuals. Combining (255) the decoded prediction residuals and the predicted block, an image block is reconstructed. In-loop filters (265) are applied to the reconstructed picture to perform, for example, deblocking/SAO (Sample Adaptive Offset) filtering to reduce encoding artifacts. The filtered image is stored at a reference picture buffer (280).

FIG. 3 is a diagram showing an example of a video decoder. In example decoder 300, a bitstream is decoded by the decoder elements as described below. Video decoder 300 generally performs a decoding pass reciprocal to the encoding pass as described in FIG. 2. The encoder 200 also generally performs video decoding as part of encoding video data.

In particular, the input of the decoder includes a video bitstream, which may be generated by video encoder 200. The bitstream is first entropy decoded (330) to obtain transform coefficients, motion vectors, and other coded information. The picture partition information indicates how the picture is partitioned. The decoder may therefore divide (335) the picture according to the decoded picture partitioning information. The transform coefficients are de-quantized (340) and inverse transformed (350) to decode the prediction residuals. Combining (355) the decoded prediction residuals and the predicted block, an image block is reconstructed. The predicted block may be obtained (370) from intra prediction (360) or motion-compensated prediction (i.e., inter prediction) (375). In-loop filters (365) are applied to the reconstructed image. The filtered image is stored at a reference picture buffer (380).

The decoded picture can further go through post-decoding processing (385), for example, an inverse color transform (e.g. conversion from YCbCr 4:2:0 to RGB 4:4:4) or an inverse remapping performing the inverse of the remapping process performed in the pre-encoding processing (201). The post-decoding processing can use metadata derived in the pre-encoding processing and signaled in the bitstream. In an example, the decoded images (e.g., after application of the in-loop filters (365) and/or after post-decoding processing (385), if post-decoding processing is used) may be sent to a display device for rendering to a user.

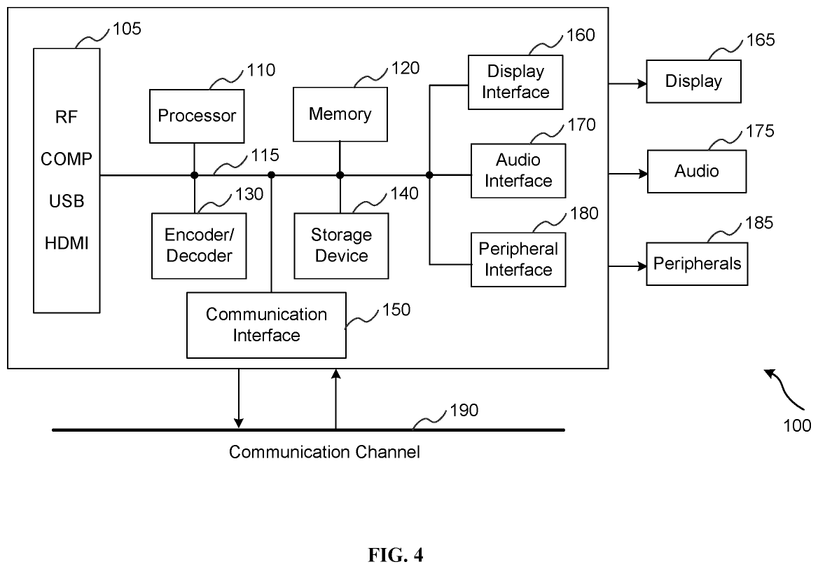

FIG. 4 is a diagram showing an example of a system in which various aspects and examples described herein may be implemented. System 400 may be embodied as a device including the various components described below and is configured to perform one or more of the aspects described in this document. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 400, singly or in combination, may be embodied in a single integrated circuit (IC), multiple ICs, and/or discrete components. For example, in at least one example, the processing and encoder/decoder elements of system 400 are distributed across multiple ICs and/or discrete components. In various examples, the system 400 is communicatively coupled to one or more other systems, or other electronic devices, via, for example, a communications bus or through dedicated input and/or output ports. In various examples, the system 400 is configured to implement one or more of the aspects described in this document.

The system 400 includes at least one processor 410 configured to execute instructions loaded therein for implementing, for example, the various aspects described in this document. Processor 410 can include embedded memory, input output interface, and various other circuitries as known in the art. The system 400 includes at least one memory 420 (e.g., a volatile memory device, and/or a non-volatile memory device). System 400 includes a storage device 440, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive. The storage device 440 can include an internal storage device, an attached storage device (including detachable and non-detachable storage devices), and/or a network accessible storage device, as non-limiting examples.

System 400 includes an encoder/decoder module 430 configured, for example, to process data to provide an encoded video or decoded video, and the encoder/decoder module 430 can include its own processor and memory. The encoder/decoder module 430 represents module(s) that may be included in a device to perform the encoding and/or decoding functions. As is known, a device can include one or both of the encoding and decoding modules. Additionally, encoder/decoder module 430 may be implemented as a separate element of system 400 or may be incorporated within processor 410 as a combination of hardware and software as known to those skilled in the art.

Program code to be loaded onto processor 410 or encoder/decoder 430 to perform the various aspects described in this document may be stored in storage device 440 and subsequently loaded onto memory 420 for execution by processor 410. In accordance with various examples, one or more of processor 410, memory 420, storage device 440, and encoder/decoder module 430 can store one or more of various items during the performance of the processes described in this document. Such stored items can include, but are not limited to, the input video, the decoded video or portions of the decoded video, the bitstream, matrices, variables, and intermediate or final results from the processing of equations, formulas, operations, and operational logic.

In some examples, memory inside of the processor 410 and/or the encoder/decoder module 430 is used to store instructions and to provide working memory for processing that is needed during encoding or decoding. In other examples, however, a memory external to the processing device (for example, the processing device may be either the processor 410 or the encoder/decoder module 430) is used for one or more of these functions. The external memory may be the memory 420 and/or the storage device 440, for example, a dynamic volatile memory and/or a non-volatile flash memory. In several examples, an external non-volatile flash memory is used to store the operating system of, for example, a television. In at least one example, a fast external dynamic volatile memory such as a RAM is used as working memory for video encoding and decoding operations.

The input to the elements of system 400 may be provided through various input devices as indicated in block 445. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 4, include composite video.

In various examples, the input devices of block 445 have associated respective input processing elements as known in the art. For example, the RF portion may be associated with elements suitable for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which may be referred to as a channel in certain examples, (iv) demodulating the downconverted and band-limited signal, (v) performing error correction, and/or (vi) demultiplexing to select the desired stream of data packets. The RF portion of various examples includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, downconverting the received signal to a lower frequency (for example, an intermediate frequency or a near-baseband frequency) or to baseband. In one set-top box example, the RF portion and its associated input processing element receives an RF signal transmitted over a wired (for example, cable) medium, and performs frequency selection by filtering, downconverting, and filtering again to a desired frequency band. Various examples rearrange the order of the above-described (and other) elements, remove some of these elements, and/or add other elements performing similar or different functions. Adding elements can include inserting elements in between existing elements, such as, for example, inserting amplifiers and an analog-to-digital converter. In various examples, the RF portion includes an antenna.

The USB and/or HDMI terminals can include respective interface processors for connecting system 400 to other electronic devices across USB and/or HDMI connections. It is to be understood that various aspects of input processing, for example, Reed-Solomon error correction, may be implemented, for example, within a separate input processing IC or within processor 410 as necessary. Similarly, aspects of USB or HDMI interface processing may be implemented within separate interface ICs or within processor 410 as necessary. The demodulated, error corrected, and demultiplexed stream is provided to various processing elements, including, for example, processor 410, and encoder/decoder 430 operating in combination with the memory and storage elements to process the datastream as necessary for presentation on an output device.

Various elements of system 400 may be provided within an integrated housing, Within the integrated housing, the various elements may be interconnected and transmit data therebetween using suitable connection arrangement 425, for example, an internal bus as known in the art, including the Inter-IC (12C) bus, wiring, and printed circuit boards.

The system 400 includes communication interface 450 that enables communication with other devices via communication channel 460. The communication interface 450 can include, but is not limited to, a transceiver configured to transmit and to receive data over communication channel 460. The communication interface 450 can include, but is not limited to, a modem or network card and the communication channel 460 may be implemented, for example, within a wired and/or a wireless medium.

Data is streamed, or otherwise provided, to the system 400, in various examples, using a wireless network such as a Wi-Fi network, for example IEEE 802.11 (IEEE refers to the Institute of Electrical and Electronics Engineers). The Wi-Fi signal of these examples is received over the communications channel 460 and the communications interface 450 which are adapted for Wi-Fi communications. The communications channel 460 of these examples is typically connected to an access point or router that provides access to external networks including the Internet for allowing streaming applications and other over-the-top communications. Other examples provide streamed data to the system 400 using a set-top box that delivers the data over the HDMI connection of the input block 445. Still other examples provide streamed data to the system 400 using the RF connection of the input block 445. As indicated above, various examples provide data in a non-streaming manner. Additionally, various examples use wireless networks other than Wi-Fi, for example a cellular network or a Bluetooth® network.

The system 400 can provide an output signal to various output devices, including a display 475, speakers 485, and other peripheral devices 495. The display 475 of various examples includes one or more of, for example, a touchscreen display, an organic light-emitting diode (OLED) display, a curved display, and/or a foldable display. The display 475 may be for a television, a tablet, a laptop, a cell phone (mobile phone), or other device. The display 475 can also be integrated with other components (for example, as in a smart phone), or separate (for example, an external monitor for a laptop). The other peripheral devices 495 include, in various examples, one or more of a stand-alone digital video disc (or digital versatile disc) (DVD, for both terms), a disk player, a stereo system, and/or a lighting system. Various examples use one or more peripheral devices 495 that provide a function based on the output of the system 400. For example, a disk player performs the function of playing the output of the system 400.

In various examples, control signals are communicated between the system 400 and the display 475, speakers 485, or other peripheral devices 495 using signaling such as AV.Link, Consumer Electronics Control (CEC), or other communications protocols that enable device-to-device control with or without user intervention. The output devices may be communicatively coupled to system 400 via dedicated connections through respective interfaces 470, 480, and 490. Alternatively, the output devices may be connected to system 400 using the communications channel 460 via the communications interface 450. The display 475 and speakers 485 may be integrated in a single unit with the other components of system 400 in an electronic device such as, for example, a television. In various examples, the display interface 470 includes a display driver, such as, for example, a timing controller (T Con) chip.

The display 475 and speakers 485 can alternatively be separate from one or more of the other components, for example, if the RF portion of input 445 is part of a separate set-top box. In various examples in which the display 475 and speakers 485 are external components, the output signal may be provided via dedicated output connections, including, for example, HDMI ports, USB ports, or COMP outputs.

The examples may be carried out by computer software implemented by the processor 410 or by hardware, or by a combination of hardware and software. As a non-limiting example, the examples may be implemented by one or more integrated circuits. The memory 420 may be of any type appropriate to the technical environment and may be implemented using any appropriate data storage technology, such as optical memory devices, magnetic memory devices, semiconductor-based memory devices, fixed memory, and removable memory, as non-limiting examples. The processor 410 may be of any type appropriate to the technical environment, and can encompass one or more of microprocessors, general purpose computers, special purpose computers, and processors based on a multi-core architecture, as non-limiting examples.

Various implementations involve decoding. “Decoding”, as used in this application, can encompass all or part of the processes performed, for example, on a received encoded sequence in order to produce a final output suitable for display. In various examples, such processes include one or more of the processes typically performed by a decoder, for example, entropy decoding, inverse quantization, inverse transformation, and differential decoding. In various examples, such processes also, or alternatively, include processes performed by a decoder of various implementations described in this application, for example, performing decoding using an intra-prediction mode (e.g., a planar intra-prediction mode, such as a directional planar intra-prediction mode), etc.

As further examples, in one example “decoding” refers only to entropy decoding, in another example “decoding” refers only to differential decoding, and in another example “decoding” refers to a combination of entropy decoding and differential decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video sequence in order to produce an encoded bitstream. In various examples, such processes include one or more of the processes typically performed by an encoder, for example, partitioning, differential encoding, transformation, quantization, and entropy encoding. In various examples, such processes also, or alternatively, include processes performed by an encoder of various implementations described in this application, for example, determining that a planar intra-prediction mode is used, indicating intra-prediction mode information, etc.

As further examples, in one example “encoding” refers only to entropy encoding, in another example “encoding” refers only to differential encoding, and in another example “encoding” refers to a combination of differential encoding and entropy encoding. Whether the phrase “encoding process” is intended to refer specifically to a subset of operations or generally to the broader encoding process will be clear based on the context of the specific descriptions and is believed to be well understood by those skilled in the art.

Note that syntax elements as used herein, for example, coding syntax on ISP, SGPM, DIMD, TIMD, MPM, etc., are descriptive terms. As such, they do not preclude the use of other syntax element names.

When a figure is presented as a flow diagram, it should be understood that it also provides a block diagram of a corresponding apparatus. Similarly, when a figure is presented as a block diagram, it should be understood that it also provides a flow diagram of a corresponding method/process.

The implementations and aspects described herein may be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus may be implemented in, for example, appropriate hardware, software, and firmware. The methods may be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one example” or “an example” or “one implementation” or “an implementation”, as well as other variations thereof, means that a particular feature, structure, characteristic, and so forth described in connection with the example is included in at least one example. Thus, the appearances of the phrase “in one example” or “in an example” or “in one implementation” or “in an implementation”, as well any other variations, appearing in various places throughout this application are not necessarily all referring to the same example.

Additionally, this application may refer to “determining” various pieces of information. Determining the information can include one or more of, for example, estimating the information, calculating the information, predicting the information, or retrieving the information from memory. Obtaining may include receiving, retrieving, constructing, generating, and/or determining.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. Encoder signals may include, for example, signals associated with ISP (e.g., isp_flag, isp_mode), DIMD (e.g., dimd_flag), TIMD (e.g., timd_flag, SGPM (e.g., sgpm_flag, sgpm_cand_idx), MPM (e.g., non_mpm_index), etc. In this way, in an example the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling may be used without transmitting (implicit signaling) to simply allow the decoder to know and select the particular parameter. By avoiding transmission of any actual functions, a bit savings is realized in various examples. It is to be appreciated that signaling may be accomplished in a variety of ways. For example, one or more syntax elements, flags, and so forth are used to signal information to a corresponding decoder in various examples. While the preceding relates to the verb form of the word “signal”, the word “signal” can also be used herein as a noun.

As will be evident to one of ordinary skill in the art, implementations may produce a variety of signals formatted to carry information that may be, for example, stored or transmitted. The information can include, for example, instructions for performing a method, or data produced by one of the described implementations. For example, a signal may be formatted to carry the bitstream of a described example. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on, or accessed or received from, a processor-readable medium.

Many examples are described herein. Features of examples may be provided alone or in any combination, across various claim categories and types. Further, examples may include one or more of the features, devices, or aspects described herein, alone or in any combination, across various claim categories and types. For example, features described herein may be implemented in a bitstream or signal that includes information generated as described herein. The information may allow a decoder to decode a bitstream, the encoder, bitstream, and/or decoder according to any of the embodiments described. For example, features described herein may be implemented by creating and/or transmitting and/or receiving and/or decoding a bitstream or signal. For example, features described herein may be implemented a method, process, apparatus, medium storing instructions, medium storing data, or signal. For example, features described herein may be implemented by a TV, set-top box, cell phone, tablet, or other electronic device that performs decoding. The TV, set-top box, cell phone, tablet, or other electronic device may display (e.g. using a monitor, screen, or other type of display) a resulting image (e.g., an image from residual reconstruction of the video bitstream). The TV, set-top box, cell phone, tablet, or other electronic device may receive a signal including an encoded image and perform decoding.

Systems, methods, and instrumentalities are disclosed for performing planar horizontal mode, planar vertical mode, and/or planar directional mode intra-prediction. Planar intra-prediction modes may be used in video coding for coding blocks. Planar intra-prediction modes may be determined to be used based on indicated parameters, modes, neighboring blocks, gradients, templates, etc. Planar intra-prediction modes may be used to determine parameters. Directionality of planar intra-prediction modes may be used to determine a reference region and/or template. For example, a cross-component linear model (CCLM) or a multi-model linear model mode may be determined based on the direction of the planar mode. A reference region of chroma decoder-side intra mode derivation (DIMD) or convolutional cross-component model (CCCM) for a chroma block may be determined based on a planar mode associated with a collocated luma block. For example, a reference region or template for template-based intra mode derivation (TIMD) or spatial geometric partitioning mode (SGPM) may be determined based on the direction of the planar mode.

For example, a device (e.g., video encoder, video decoder) may determine a reference region and/or template for coding tools based on a direction of a determined planar mode (e.g., without explicit signaling). The device may determine a planar intra-prediction mode associated with a first coding block (e.g., first luma block, collocated luma block). A plurality of reconstructed neighboring samples may be identified, for example, based on the determined planar intra-prediction mode. For example, reconstructed neighboring samples may be associated with a left boundary of the second coding block if the planar intra-prediction mode is horizontal planar mode. The reconstructed neighboring samples may be associated with a top boundary of the second coding block if the planar intra-prediction mode is vertical planar mode. The reconstructed neighboring samples may be associated with both a top boundary and a left boundary of the second coding block if the planar intra-prediction mode is conventional planar mode. A decoding and/or encoding function may be performed on a second coding block (e.g., second luma block, chroma block). based on the identified reconstructed neighboring samples.

CCLM modes (e.g., CCLM_LT, CCLM_L and CCLM_T) and MMLM modes (e.g., MMLM_LT, MMLM_L and MMLM_T) may be enabled for the chroma components. The CCLM and/or MMLM modes may be determined based on the direction of the planar mode. Those CCLM/MMLM modes may differ with respect to the locations of the reference samples that are used for model parameter derivation. Samples from the top boundary may be involved in the CCLM_T/MMLM_T mode and samples from the left boundary may be involved in the CCLM_L/MMLM_L mode. In the CCLM_LT/MMLM_LT mode, samples from both the top boundary and the left boundary may be used.

For example, a video decoding device may determine to use a planar intra-prediction mode based on intra-prediction mode information. The intra-prediction mode information may indicate whether an intra-prediction mode to be used is a directional planar intra-prediction mode or a conventional planar intra-prediction mode. For example, video decoding device may determine (e.g., based on the intra-prediction mode information) that a planar intra-prediction mode is used based on a determined decode-side intra mode derivation (DIMD) mode. The video decoding device may determine the DIMD mode. The video decoding device may determine (e.g., based on the intra-prediction mode information) that a planar intra-prediction mode is used based on a determined gradient (e.g., horizontal gradient and/or vertical gradient). The video decoding device may determine (e.g., based on the intra-prediction mode information) that a planar intra-prediction mode is used based on a determined block shape associated with the coding block. The video decoding device may determine (e.g., based on the intra-prediction mode information) that a planar intra-prediction mode is used based on neighboring blocks (e.g., intra-modes associated with the neighboring blocks). The video decoding device may determine (e.g., based on the intra-prediction mode information) that a planar intra-prediction mode is used based on a determined template. The video decoding device may determine that a planar intra-prediction mode is used based on the planar intra-prediction mode being included in a most probable mode (MPM) list.

For example, a video decoding device may determine to use a planar intra-prediction mode on a chroma block. The planar intra-prediction mode may be determined to be used on a chroma block based on a collocated luma block. The planar intra-prediction mode may be determined to be used on a chroma block direct mode associated with a collocated luma block.

Systems, methods, and instrumentalities described herein may involve a decoder. In some examples, the systems, methods, and instrumentalities described herein may involve an encoder. In some examples, the systems, methods, and instrumentalities described herein may involve a signal (e.g., from an encoder and/or received by a decoder). A computer-readable medium may include instructions for causing one or more processors to perform methods described herein. A computer program product may include instructions which, when the program is executed by one or more processors, may cause the one or more processors to carry out the methods described herein. In the context of video compression, planar horizontal mode and planar vertical mode may be used. For example, DIMD/ISP/MPM list/Chroma mode list may include planar horizontal/vertical predictors to improve the prediction quality. For example, certain parameters could be considered, for example, to infer the planar mode to reduce the signaling overhead and searching complexity. For example, planar horizontal/vertical mode may be used to choose the CCLM/MMLM mode, the reference region of TIMD/SGPM/chroma DIMD/CCCM, or the split direction of intra-sub partition (ISP), for example, to further reduce the signaling overhead and calculation complexity. Interactions between planar directional (e.g., diagonal) mode with other tools may be leveraged. DC modes (e.g., two additional DC modes) may be leveraged, for example, such as DC horizontal and/or DC vertical.

Compression efficiency may be improved, for example, reducing the bitrate while maintaining the quality or improving the quality while maintaining the bitrate.

Intra prediction may be used to remove correlation within local regions of a picture. An assumption used for intra prediction may include that texture of a picture region is similar to the texture in the local neighborhood (e.g., and may be predicted from there). The direct neighbor samples may be employed for prediction, e.g., samples from the sample line above the current block and samples from the last column of the reconstructed blocks to the left of the current block.

Intra prediction samples may be generated using reference samples, for example, that may be obtained from reconstructed samples of neighboring blocks. FIG. 5 illustrates an example current block with neighboring reconstructed blocks. For a block of width W and height H (e.g., as shown in FIG. 5), the reference samples may include the 2×H reconstructed samples to the left of the block, the top left reconstructed sample, and the 2×W reference samples above the block. Unavailable reference samples may be generated, for example, by a padding mechanism.

Intra mode coding may be performed, for example, with 67 intra prediction modes.

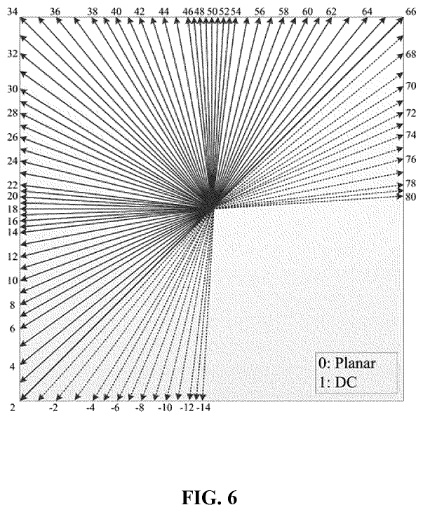

The number of directional intra modes may be extended (e.g., from 33 to 65, for example, as depicted in FIG. 6), for example, to capture the edge directions (e.g., arbitrary edge directions) presented in natural video and the planar and DC modes may remain the same. These denser directional intra prediction modes may apply for different block sizes (e.g., all block sizes) and for both luma and chroma intra predictions.

For a square coding unit, (e.g., only) conventional angular intra prediction modes 2-66 may be used. These prediction modes may correspond to angular intra prediction directions that may be defined from 45 degrees to −135 degrees in a clockwise direction.

Conventional angular intra prediction modes may be adaptively replaced with wide angular intra prediction modes (e.g., for non-square blocks). FIG. 6 illustrates example wide angular intra prediction modes. As dotted arrows shown in FIG. 6, the wide angular modes beyond the bottom-left direction modes may be indexed from −14 to −1, the wide angular modes beyond the top-right direction may be indexed from 67 to 80. For some horizontal-oriented blocks (e.g., W>H) and vertical-oriented blocks (e.g., W<H), wide angular modes may be used to replace equal number of regular angular modes in the opposite direction. Reference sample smoothing and interpolation filtering may be performed.

Intra prediction may use two filtering mechanisms applied to reference samples, for example, reference sample smoothing and/or interpolation filtering. Reference sample smoothing may be applied (e.g., only) to integer-slope modes in luma blocks. Interpolation filtering may be applied to fractional-slope modes.

For reference sample smoothing, the reference samples may be filtered using the finite impulse response filter. The predicted sample value may be obtained by applying an interpolation filter to the reference samples around the fractional sample position, for example, if (e.g., when) a sample projection for a given prediction direction falls on a fractional position between reference samples.

One or more of the following reference samples processing may be performed, for example, depending on the intra prediction mode.

The directional intra-prediction mode may be classified into one of the following groups: Group A: horizontal or vertical modes (e.g., HOR_IDX, VER_IDX); Group B: directional modes that represent non-fractional angles (e.g., −14, −12, −10, −6, 2, 34, 66, 72, 76, 78, 80, etc.) and planar mode; or Group C: remaining directional modes.

Filters may be refrained from being applied (e.g., no filters are applied) to reference samples to generate predicted samples, for example, if the directional intra-prediction mode is classified as belonging to group A.

A reference sample filter may be applied to reference samples to further copy these filtered values into an intra predictor according to the selected direction (e.g., but no interpolation filters are applied), for example, if a mode falls into group B and the mode is a directional mode, and for a given luma block with some constraints.

An (e.g., only an) intra reference sample interpolation filter may be applied to reference samples to generate a predicted sample that falls into a fractional or integer position between reference samples according to a selected direction (e.g., no reference sample filtering is performed), for example, if a mode is classified as belonging to group C, and for a given block with some constraints.

Position dependent prediction combination (PDPC) may be performed.

The results of intra prediction of DC, planar and several angular modes may be further modified by performing position dependent intra prediction combination (PDPC). PDPC may be used to combine the intra prediction block samples with unfiltered or filtered boundary reference samples, for example, by employing intra mode and position dependent weighting.

The prediction sample Pred(x,y) located at (x,y) may be calculated (e.g., if PDPC is applied) according to Eq. 1:

$$Pred ( x , y ) = ( {w}_{L} * {Ref}_{L} + {w}_{T} * {Ref}_{T} + ( 64 - {w}_{L} - {w}_{T} ) * Pred ( x , y ) + 32 ) >> 6 \qquad Eq . 1$$

where w_{L} and w_{T} may include the position dependent weights, Ref_{L} and Ref_{T} may include the neighboring reference samples at the left and top of the current block, respectively. The operations»and «may represent binary right and left shift, respectively. The reference samples and position dependent weights may be defined for each mode (e.g., examples for some intra modes described herein).

For Planar and DC modes, the reference samples Ref_{L} and Ref_{T} may have the following coordinates (e.g., as described in Eq. 2), where Ref(x,y) may be the array of reconstructed neighboring samples:

$${Ref}_{L} ( x , y ) = Ref ( - 1 , y ) , \qquad Eq . 2$$

$${Ref}_{T} ( x , y ) = Ref ( x , - 1 )$$

The position dependent weights w_{L} and w_{T} may be calculated with Eq. 3 as follows:

$${w}_{T} = 32 >> ( ( y << 1 ) >> scale ) , \qquad Eq . 3$$

$${w}_{L} = 32 >> ( ( x << 1 ) >> scale ) ,$$

$$scale = ( {log}_{2} ( width ) + {log}_{2} ( height ) - 2 ) >> 2$$

For Horizontal and Vertical intra modes (e.g., HOR_IDX, VER_IDX), the reference samples Ref_{L} and Ref_{T} may have the following coordinates (e.g., as described in Eq. 4), where Ref(x,y) may be the array of reconstructed neighboring samples and Ref(−1, −1) represents the top-left neighboring reference sample:

$${Ref}_{L} ( x , y ) = Ref ( - 1 , y ) - Ref ( - 1 , - 1 ) + Pred ( x , y ) , \qquad Eq . 4$$

$${Ref}_{T} ( x , y ) = Ref ( x , - 1 ) - Ref ( - 1 , - 1 ) + Pred ( x , y ) ,$$

The position dependent weights w_{L} and w_{T} may be determined as follows. For Horizontal mode, the weight w_{T} may be determined as in Eq. 3 and w_{L}=0; while for Vertical mode, the weight w_{L} may be determined as in Eq. (3) and w_{T}=0.

Multiple reference line (MRL) intra prediction may be performed.

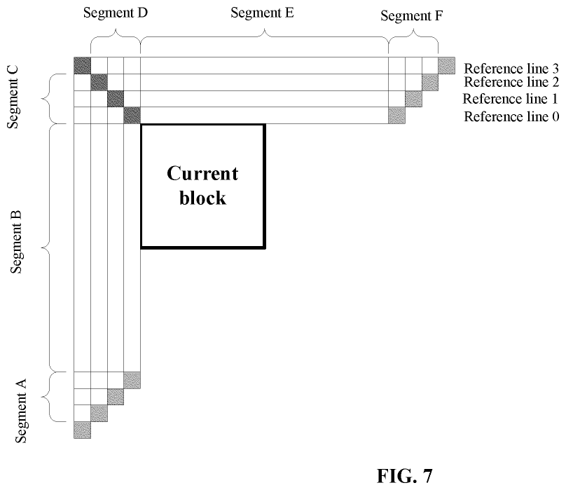

Multiple reference line (MRL) intra prediction may use more reference lines (e.g., as compared to other intra prediction modes) for intra prediction. MRL prediction mode may be motivated by the observation that non-adjacent reference lines are (e.g., mainly) beneficial for some texture patterns (e.g., texture patterns with sharp and strongly directed edges). MRL prediction mode may be (e.g., expected to be) less useful, for example, if texture patterns are smooth. FIG. 7 illustrates MRL intra prediction using multiple reference lines. As shown in FIG. 7, an example of 4 reference lines is depicted, where the samples of segments A and F may be refrained from being fetched (e.g., not be fetched) from reconstructed neighboring samples (e.g., but padded with the closest samples from Segment B and E, respectively). For example, intra-picture prediction may use the nearest reference line (e.g., reference line 0). For example, MRL intra prediction may use multiple (e.g., 2 additional) lines (e.g., reference line 1 and reference line 2).

The index of selected reference line mrl_idx may be signaled and may be used to generate intra predictor.

Intra sub partition (ISP) may be performed.

The intra sub-partitions (ISP) may be used to divide luma intra-predicted blocks vertically or horizontally into sub-partitions (e.g., 2 or 4 sub-partitions), for example, depending on the block size. FIG. 8 illustrates an example of ISP. FIG. 8 shows examples of the two possibilities. The reconstructed sample values of the (e.g., each) sub-partition may be used (e.g., available) to generate the prediction of the next sub-partition, and the (e.g., each) sub-partition may be processed sequentially. The (e.g., all) sub-partitions may fulfill the condition of having at least 16 samples and (e.g., also) share the same intra mode. In ISP mode, (e.g., all) 67 intra modes may be allowed.

For a (e.g., each) intra-coded block, an indication (e.g., flag e.g., isp_flag) indicating whether an ISP may be (e.g., is to be) applied or not may be signaled. Another syntax (e.g., isp_mode) to specify the split vertically or horizontally may be signaled, for example, on a condition that isp_flag is true (e.g., based on determining that isp_flag is true).

Decoder side intra mode derivation (DIMD) may be performed.

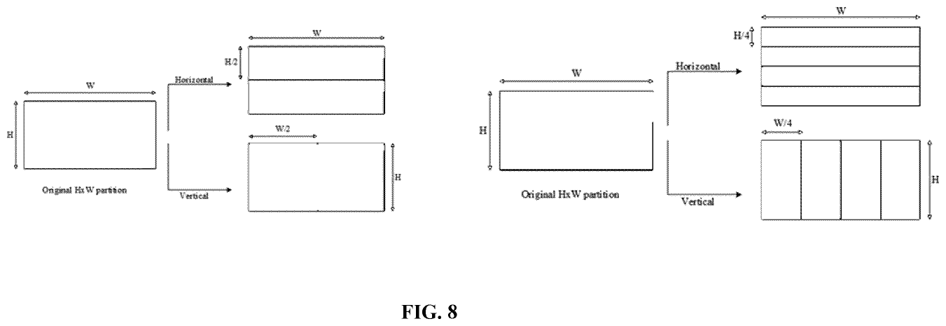

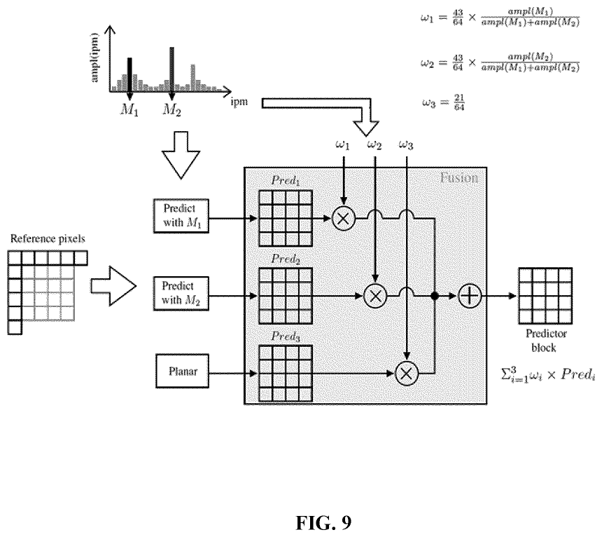

Decoder side Intra Mode Derivation (DIMD) may be used to derive the intra mode used to code a coding unit (CU). FIG. 9 illustrates an example use of DIMD. When DIMD is applied, two intra prediction modes IPM_{dimd_1st} and IPM_{dimd_2nd} that may be the two best intra prediction modes for predicting the current coding unit (CU), may be derived from a Histogram of Oriented Gradients (HOG) computed from the neighboring pixels of a current block. Those two predictors DIMD₁ₛₜ and DIMD_{2nd} may be combined with the planar mode predictor DIMDₚₗₐₙₐᵣ with the weights w₁ and w₂ derived from the HOG in this template, as illustrated in FIG. 9.

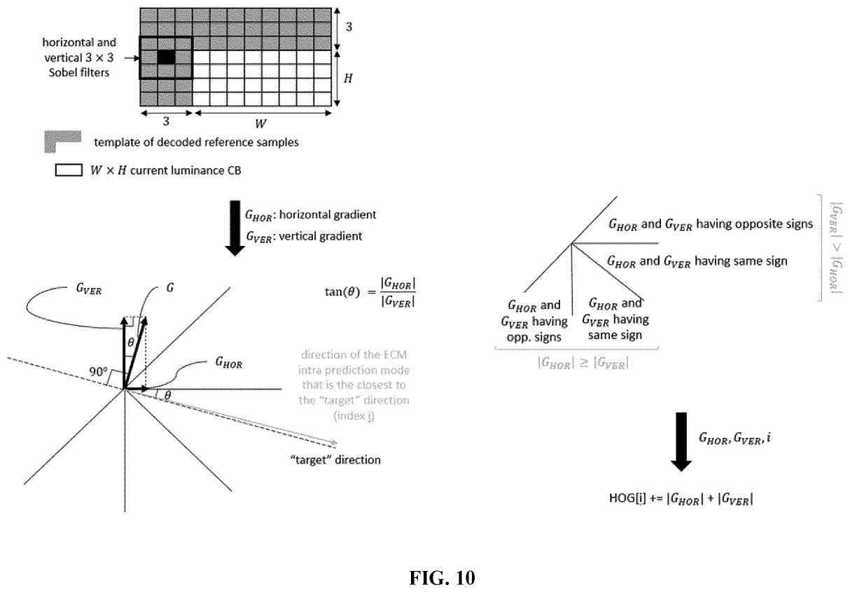

For the current CU, the two intra prediction modes may be derived from the gradients in the template as depicted in FIG. 10. FIG. 10 illustrates an example of deriving intra prediction modes for DIMD using a template. A HOG with multiple bins (e.g., 65 bins corresponding to the 65 directional intra prediction modes) may be initialized to 0. For the (e.g., each) decoded reference sample in the middle row or the middle column of the template of three rows of decoded reference samples above the current CU and three columns of decoded reference samples on its left side, the following procedure may apply.

A 3×3 horizontal Sobel filter and a 3×3 vertical Sobel filter (e.g., both centered at the decoded reference sample) may yield a horizontal gradient G_{HOR} and a vertical gradient G_{VER} respectively.

The signs of G_{HOR} and G_{VER} may indicate in which of the four ranges of directions is found the “target” direction being perpendicular to the gradient G of horizontal component G_{HOR} and vertical component G_{VER}. The anchor direction may correspond to the horizontal direction, for example, if |G_{VER}|>|G_{HOR}|. The anchor direction may correspond to the vertical direction, for example, if | G_{HOR}|≥ |G_{VER}|. The target direction may form an angle θ with respect to the anchor direction.

The index i of the intra prediction mode whose direction is the closest to the target direction may be found, for example, by discretizing a scaled version of tan(θ).

The HOG bin of index i may be incremented by |G_{HOR}|+|G_{VER}|.

The indices of the (e.g., two largest) HOG bins may be the indices of the (e.g., two) derived intra prediction modes IPM_{dimd_1st} and IPM_{dimd_2nd}.

For an (e.g., each) intra-coded block, an indication (e.g., flag e.g., dimd_flag) indicating whether a DIMD mode may be (e.g., is to be) applied or not may be signaled. The DIMD mode may be (e.g., always) available for the intra prediction block, for example, because the DIMD mode may be considered as one of the Most Probable Mode (MPM) candidates.

Fusion for template-based intra mode derivation (TIMD) may be performed.

The intra mode used to code a CU may be derived using the Fusion for Template-based Intra Mode Derivation (TIMD), and the process may include the following.

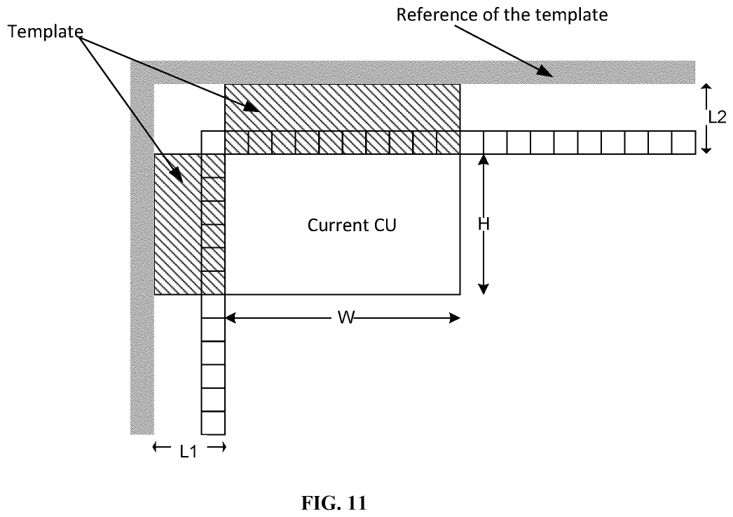

For an (e.g., each) intra prediction mode in most probable modes (MPMs), the Sum of Absolute Transformed Differences (SATD) between the prediction and reconstruction samples of the template may be calculated as depicted in FIG. 11. FIG. 11 illustrates a CU and its neighboring reconstructed samples for calculating the SATD. As shown in FIG. 11, the current CU may be of size W×H and the template may include left already reconstructed samples of size L1×H and above already reconstructed samples of size W×L2 respectively. The prediction of the template may be obtained for the (e.g., each) intra prediction mode from the reference samples located in the reference of the template (e.g., gray part on FIG. 11). Two intra prediction modes with the minimum SATD may be selected. After retaining two intra prediction modes from the first pass of tests involving the MPM list supplemented with default modes, for each of these two modes, if this intra prediction mode is neither planar nor DC, TIMD may test (e.g., in terms of prediction SATD) its two closest extended directional intra prediction modes. For TIMD, the set of directional intra prediction modes may be extended (e.g., from 65 to 129), for example, by inserting a direction between each black solid arrow (e.g., with respect to FIG. 6). The set of possible intra prediction modes derived via TIMD may gather 131 modes. On condition that SATD_{IPM_timd_2nd}<2*SATD_{IPM_timd_1st} is true, the (e.g., final two) predictors using the selected intra prediction modes TIMD₁ₛₜ and TIMD_{2nd} may be fused with the weights (e.g., which may depend on the SATDs of the two intra prediction modes IPM_{timd_1st} and IPM_{timd_2nd}); otherwise, (e.g., only) the first intra prediction mode IPM_{timd_1st} is used.

For each intra-coded block, an indication (e.g., flag, namely timd_flag) indicating whether a TIMD mode may be (e.g., is to be) applied or not may be signaled.

Spatial Geometric Partitioning Mode (SGPM) may be used.

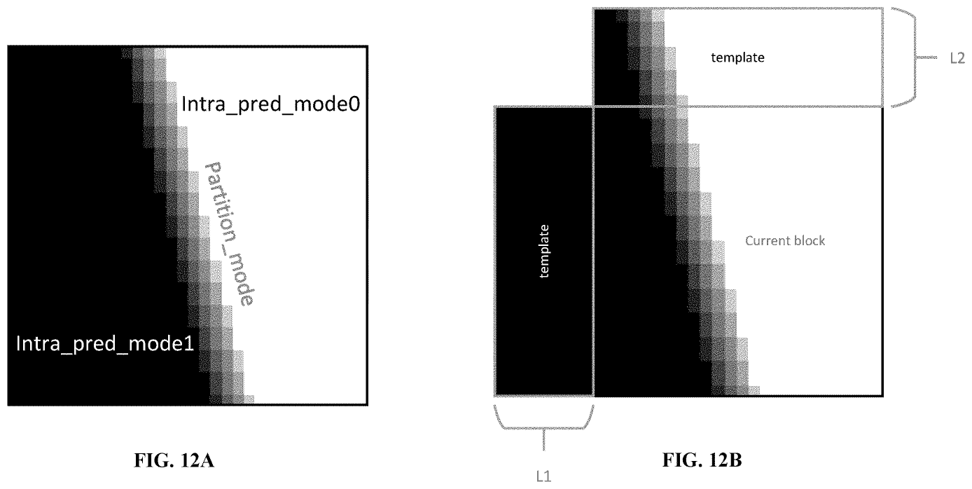

The spatial geometric partitioning mode (SGPM) may be used, which may partition a coding block into several (e.g., two) parts and may generate (e.g., two) corresponding intra-prediction modes. FIG. 12A shows an example of a SGPM block partitioned according to one partition mode into two parts, each part being associated with an intra prediction mode. In examples, (e.g., 26) predefined partition modes may be used. For a (e.g., each) partition mode, an intra prediction mode (IPM) list may be derived for each part. The IPM list size may be defined (e.g., 3). A (e.g., each possible) combination of one partition mode and two intra prediction modes of the IPM list may be considered as a SGPM candidate. The (e.g., only the) candidate index that is (e.g., effectively) used for coding may be signaled in the bit-stream.

FIG. 12B illustrates an example template for generating an SGPM candidate list. As shown in FIG. 12B, a template may be used to generate this SGPM candidate list. The shape of the template may be the same as TIMD, for example, which may comprise left already reconstructed samples of size L1×H and above already reconstructed samples of size W×L2 respectively. For a (e.g., each) possible combination of one partition mode and two intra prediction modes, a prediction may be generated for the template with the partitioning weight extended to the template. These combinations may be ranked in ascending order of their SATD between the prediction and reconstruction of the template. The length of the candidate list may be set (e.g., equal to 16), and these candidates may be regarded as the most probable SGPM combinations of the current block. Both an encoder and decoder may construct the same candidate list based on the template.

For an intra-coded block, an indication (e.g., flag e.g., sgpm_flag) indicating whether a SGPM may be (e.g., is to be) applied or not may be signaled. On a condition that sgpm_flag is true (e.g., determined to be true), another syntax (e.g., sgpm_cand_idx) may be further signaled, for example, in order to specify which combination of one partition mode and two intra prediction modes is used, e.g., which SGPM candidate of the candidate list may be used for coding.

A cross component linear model (CCLM) may be used.

The Cross Component Linear Mode (CCLM) mode may make use of inter-channel dependencies, for example, by predicting the chroma samples from reconstructed luma samples. This prediction may be carried out using a linear model according to Eq. 5.

$${Pred}_{c} ( x , y ) = a * {Rec}_{L}^{′} ( x , y ) + b \qquad Eq . 5$$

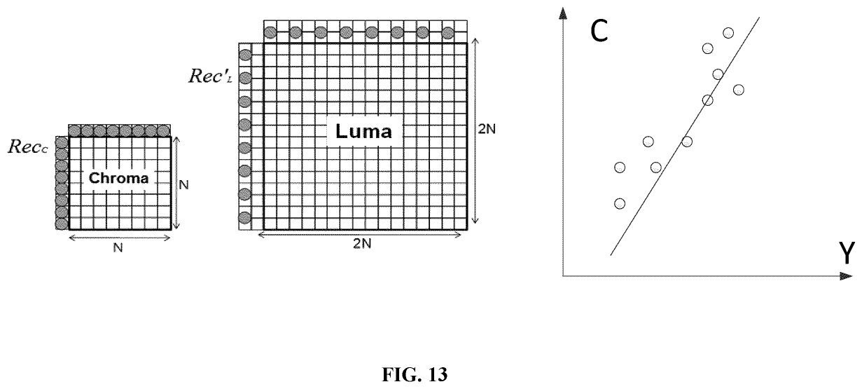

Pred_{c}(x, y) may represent the predicted chroma samples in a block and Rec′_{L}(x, y) may represent the reconstructed luma samples of the same block which may be downsampled (e.g., for the case of non-4:4:4 color format). FIG. 13 illustrates an example of reconstructing neighboring luma and chroma samples used for CCLM. As illustrated in FIG. 13, the model parameters a and b may be derived based on reconstructed neighboring luma and chroma samples at both encoder and decoder side, for example, without explicit signaling.

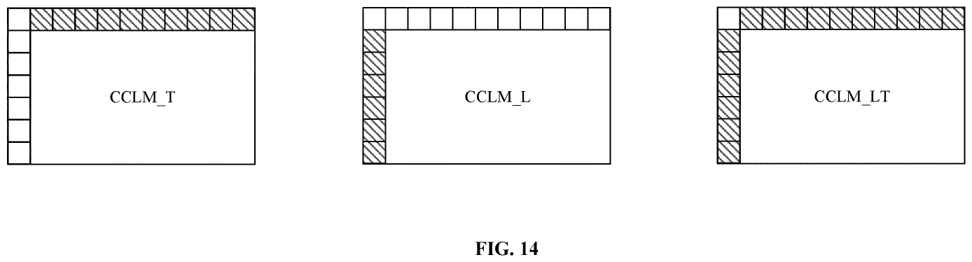

CCLM modes (e.g., three CCLM modes, such as, for example, CCLM_LT, CCLM_L and CCLM_T), may be specified. FIG. 14 illustrates example CCLM modes. These three modes may differ with respect to the locations of the reference samples that are used for model parameter derivation. As shown in FIG. 14, samples from the top boundary may be involved in the CCLM_T mode and samples from the left boundary may be involved in the CCLM_L mode. In the CCLM_LT mode, samples from both the top boundary and the left boundary may be used.

A multi-model linear model (MMLM) may be used.

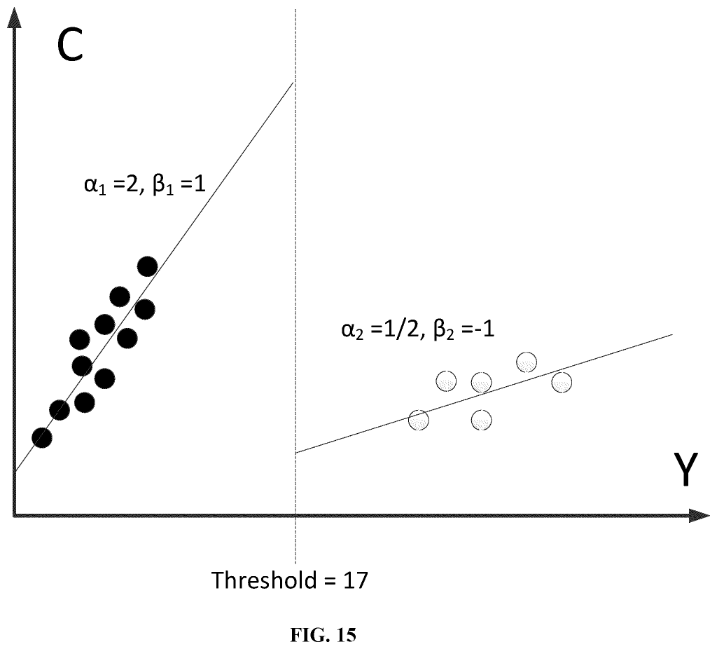

In addition to CCLM, three multi-model LM (MMLM) modes (e.g., left and top MMLM_LT, top-only MMLM_T, and left-only MMLM_L) may be used, for example, to improve the coding performance of the chroma components. In a (e.g., each) MMLM mode, the reference samples may be classified into classes (e.g., two classes) by a threshold (e.g., which may be the average of the luma reconstructed neighboring samples), and the (e.g., two) linear models may be derived based on a (e.g., each) classified luma reconstructed neighboring sample (e.g., as shown in FIG. 15). FIG. 15 illustrates an example of deriving a MMLM. The least mean squares (LMS) may be applied to derive the linear model parameters according to Eq. 6.

$$P r e {d}_{c} ( x , y ) = {a}_{1} * {Rec}_{L}^{′} ( x , y ) + {b}_{1} , if {Rec}_{L}^{′} ( x , y ) \leq threshold \qquad Eq . 6$$

$$Pre {d}_{c} ( x , y ) = {a}_{2} * {Rec}_{L}^{′} ( x , y ) + {b}_{2} , if {Rec}_{L}^{′} ( x , y ) > threshold$$

Convolutional cross-component model (CCCM) may be used.

The convolutional cross-component model (CCCM) may be used to predict chroma samples from reconstructed luma samples (e.g., similarly as done by CCLM). Similar to CCLM, the reconstructed luma samples may be downsampled to match the lower resolution chroma grid, for example, if (e.g., when) chroma sub-sampling is used.

Similar to CCLM, there may be an option of using a single model or multi-model variant of CCCM. The multi-model variant may use multiple (e.g., two) models. For example, one model may be derived for samples above the average luma reference value and another model for the rest of the samples (e.g., following the spirit of the MMLM design).

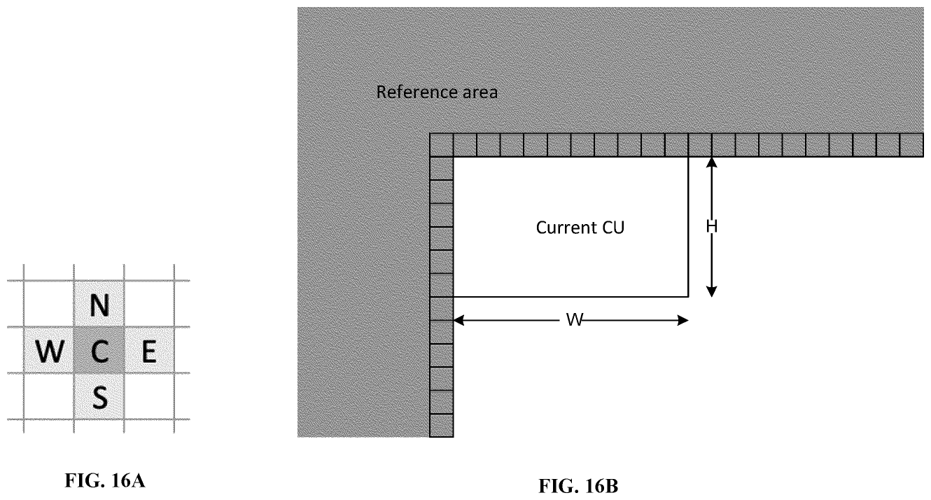

A convolutional 7-tap filter may include a 5-tap plus sign shape spatial component, a nonlinear term and a bias term. FIG. 16A illustrates an example a luma sample and collocated chroma samples. The input to the spatial 5-tap component of the filter may include a center (C) luma sample which is collocated with the chroma sample to be predicted and its above/north (N), below/south (S), left/west (W) and right/east (E) neighbors as illustrated in FIG. 16A. Output of the filter may be calculated as a convolution between the filter coefficients ci and the input values and clipped to the range of valid chroma samples, for example, according to Eq. 7.

$$P r e {d}_{c} = {c}_{0} * C + {c}_{1} * N + {c}_{2} * S + {c}_{3} * E + {c}_{4} * W + {c}_{5} * P + {c}_{6} * B \qquad Eq . 7$$

where the nonlinear term P may be represented as a power of two of the center luma sample C and scaled to the sample value range of the content, and the bias term B may represent a scalar offset between the input and output (e.g., similarly to the offset term in CCLM) and may be set to middle chroma value, for 10-bit content, the terms may be calculated according to Eq. 8.

$$P = ( C * C + 512 ) >> 10 , \qquad Eq . 8$$

$$B = 51 \; 2$$

The filter coefficients ci may be calculated by minimizing MSE between predicted and reconstructed chroma samples in the reference area. FIG. 16B illustrates an example reference area which includes 6 lines of chroma samples above and left of the block. The reference area may extend one block width to the right and one block height below the block boundaries.

Intra prediction mode signaling may be used.

The MPM list-based signaling (e.g., which may be employed for the luma block) may be used, for example, where two MPM lists are generated instead of one: primary MPM and secondary MPM. A (e.g., generic) MPM list (e.g., with 22 entries) may be built by sequentially adding candidate intra prediction mode indices, for example, from the one most likely being the selected intra prediction mode for predicting the current CU to the least likely one.

The first entry may be the planar mode. MRL may not provide additional coding gain, for example, if (e.g., when) the intra prediction mode is the planar mode (e.g., because this mode is typically used for smooth areas). The planar mode may be excluded as the first MPM entry, for example, if mrl_index is not 0.

The remaining entries may be obtained from the intra modes of the neighboring blocks in order. DIMD may be (e.g., also) used for MPM list generation. DIMD may be used to generate two directional modes IPM_{dimd_1st} and IPM_{dimd_2nd} (e.g., in addition to planar mode), and they may be added to MPM. The directional modes with added offset (±1,±2,±3,±4) from the first two available directional modes of neighboring blocks and (e.g., additionally) some predefined default modes may be included.

The intra prediction modes enabled for the chroma components may include the planar, horizontal and vertical modes (e.g., HOR_IDX, VER_IDX), DC, three CCLM modes (e.g., CCLM_LT, CCLM_L and CCLM_T), three MMLM modes (e.g., MMLM_LT, MMLM_L and MMLM_T), DIMD, and direct mode (DM) from collocated luma block.

Planar intra prediction may be performed.

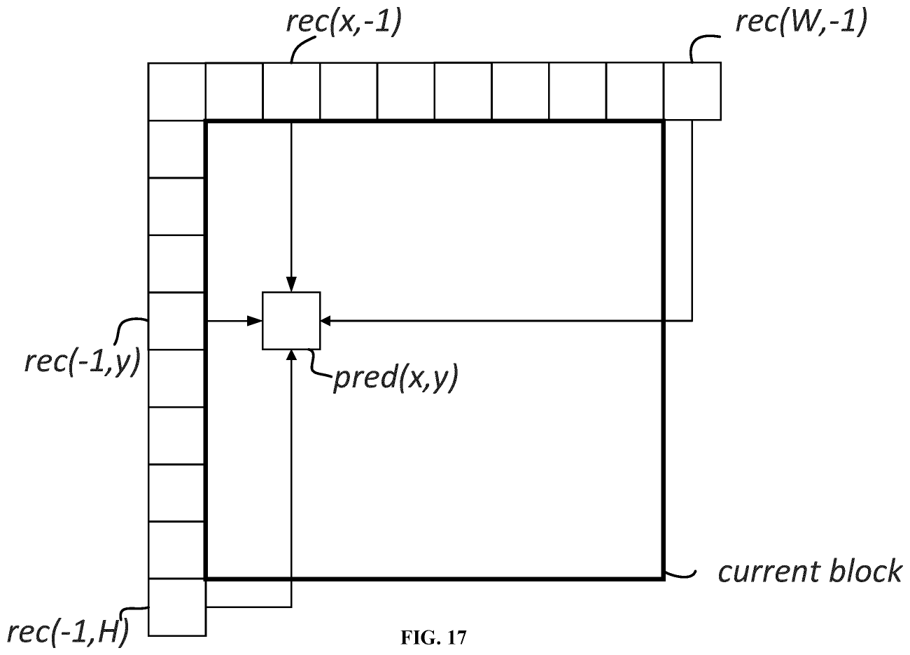

With the planar intra prediction mode, gradient structures in a block may be determined (e.g., approximated). The prediction for the block may be generated by a weighted average of (e.g., four) reference samples, for example, depending on the sample location (e.g., as shown in FIG. 17). FIG. 17 illustrates an example of using planar intra prediction. The bottom-left Rec(−1,H) and top-right Rec(W,−1) reference pixels may be used, for example, to fill the bottom row and right column (e.g., thereby forming a closed loop boundary condition for interpolation). Linear interpolation in the horizontal direction and vertical direction may be performed respectively. The two results may be averaged to obtain the predicted sample, as shown in Eq. 9.

$$PredV ( x , y ) = ( ( H - 1 - y ) * R e c ( x , - 1 ) + ( y + 1 ) * R e c ( - 1 , H ) ) << {log}_{2} W \qquad Eq . 9$$

$$PredH ( x , y ) = ( ( W - 1 - x ) * R e c ( - 1 , y ) + ( x + 1 ) * R e c ( W , - 1 ) ) << {log}_{2} H$$

$$Pred ( x , y ) = ( P r e d V ( x , y ) + P r e d H ( x , y ) + W * H ) >> ( {log}_{2} W + {log}_{2} H + 1 )$$

Planar horizontal and planar vertical intra prediction may be performed.

Planar horizontal mode and planar vertical mode may be used.

For planar horizontal mode, (e.g., only) the horizontal linear interpolation may be performed based on the left reference sample and the top-right reference sample to predict the current sample in accordance with Eq. 10.

$$Eq . 10$$

$$Pred ( x , y ) = ( ( W - 1 - x ) * R e c ( - 1 , y ) + ( x + 1 ) * R e c ( W , - 1 ) + ( W >> 1 ) ) >> {log}_{2} W$$

For planar vertical mode, (e.g., only) the vertical linear interpolation may be performed based on the above reference sample and the bottom-left reference sample to predict the current sample in accordance with Eq. 11.

$$Eq . 11$$

$$Pred ( x , y ) = ( ( H - 1 - y ) * R e c ( x , - 1 ) + ( y + 1 ) * R e c ( - 1 , H ) + ( H >> 1 ) ) >> {log}_{2} H$$

The (e.g., additional) planar modes (e.g., planar horizontal mode, planar vertical mode) may be (e.g., only) applied to the luma component and may be refrained from being used (e.g., may not be used) for ISP coded blocks. The block's propagation mode may be set to the original planar mode, for example, if (e.g., when) the current block enables one of the two proposed planar modes. For example, PDPC may be applied as done for planar mode; while reference sample smoothing may be refrained from being applied (e.g., no reference sample smoothing may be applied), for example, as what is done for horizontal or vertical mode.

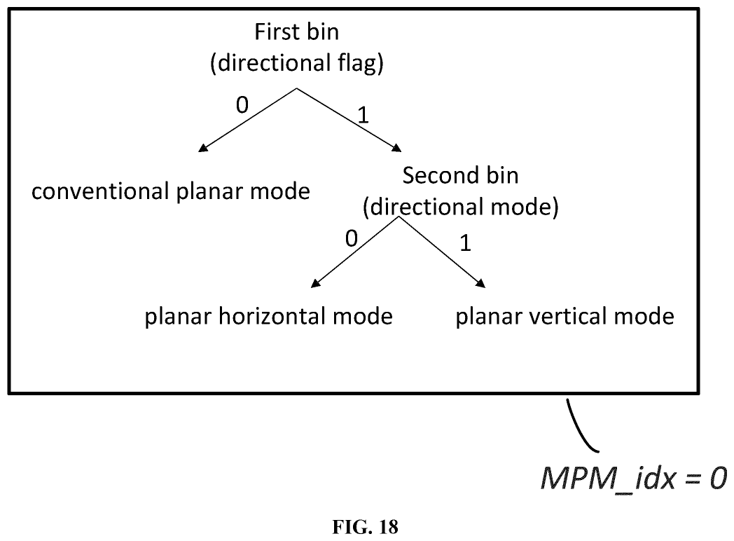

FIG. 18 illustrates example signaling for indicating a planar mode to use. For signaling (e.g., as illustrated in FIG. 18), a syntax element may be further signaled by truncated unary code to indicate which of the conventional planar mode, the planar horizontal mode and the planar vertical mode is selected to predict the current block, for example, if the planar flag indicates that a planar mode is used for the current block-when the MPM index is equal to 0, and the current block is a non-ISP coded luma block.

Planar horizontal and planar vertical intra prediction may be performed.

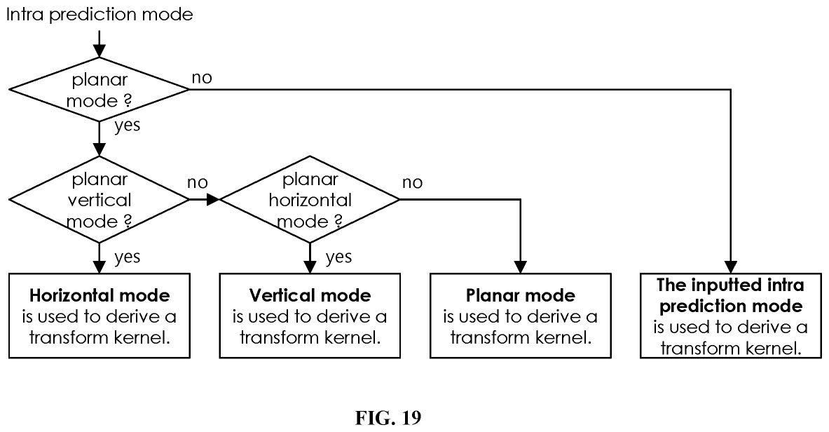

The residual characteristics of the two additional planar modes may be similar to the residual characteristics of the horizontal and vertical direction mode. The transform kernel mapping method for the planar horizontal/vertical mode may use planar vertical/horizontal mode, for example, to derive a transform kernel in multiple transform selection (MTS) set and low-frequency non-separable transform (LFNST) set (e.g., as shown in FIG. 19). FIG. 19 illustrates an example flow for determining a prediction mode used for deriving a transform kernel. The horizontal intra prediction mode may be used to derive a transform kernel in MTS set and LFNST set, for example, if an intra prediction mode of a current block is the planar vertical mode. The vertical intra prediction mode may be used to derive a transform kernel in MTS set and LFNST set, for example, if an intra prediction mode of a current block is the planar horizontal mode.

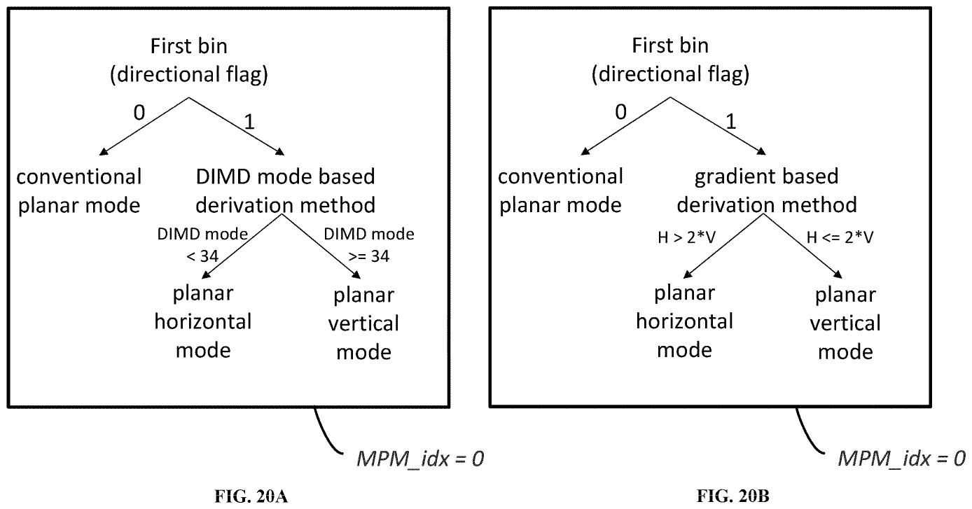

The planar directional mode may be inferred using the DIMD mode (e.g., as shown in FIG. 20A). FIG. 20A illustrates an example flow for determining a planar prediction mode. The derived DIMD mode may be (e.g., always) available in the encoder for the intra prediction block (e.g., even if dimd_flag is 0), and the DIMD mode may be derived as one of the MPM candidates. The derived DIMD mode may be used to decide on the planar mode direction. The current block may be inferred as a horizontal planar mode, for example, if the DIMD first mode is less than the mode 34 (e.g., IPM_{dimd_1st}<34). The current block may be inferred as a vertical planar mode, for example, if the DIMD first mode is equal to or greater than the mode 34 (e.g., IPM_{dimd_1st}≥34).

The planar directional mode may be inferred using a gradient based decoder side derivation method (e.g., similar to DIMD). FIG. 20B illustrates an example flow for determining a planar prediction mode. As shown in FIG. 20B, the horizontal gradient for a (e.g., each) sample in the adjacent row of the current block and the vertical gradient for a (e.g., each) sample in the adjacent column of the current block may be calculated. The horizontal planar mode may be used, for example, if the sum of the absolute values of the horizontal gradients is greater than the sum of the absolute values of the vertical gradients multiplied by a threshold (e.g., which may be equal to 2); otherwise, the vertical planar mode may be used.

Planar diagonal intra prediction may be performed.

A planar diagonal mode may be included as a variation of the diagonal mode (e.g., mode 34). The samples may be linearly interpolated (e.g., as in the planar mode) using the reference samples on the top and the left, and the estimated reference samples on the right and the bottom, of the block, for example, instead of repeating the reference samples on the top and left along the diagonal direction.

The latter reference samples may be (e.g., first) computed using linear interpolation between the top-right and the bottom-left reference samples and the estimated bottom-right sample. The estimated bottom-right sample Pred_br(x, y) may be computed in accordance with Eq. 12.

$$Pred\_br ( x , y ) = ( H * R e c ( - 1 , H ) + W * R e c ( W , - 1 ) ) / ( W + H ) \qquad Eq . 12$$

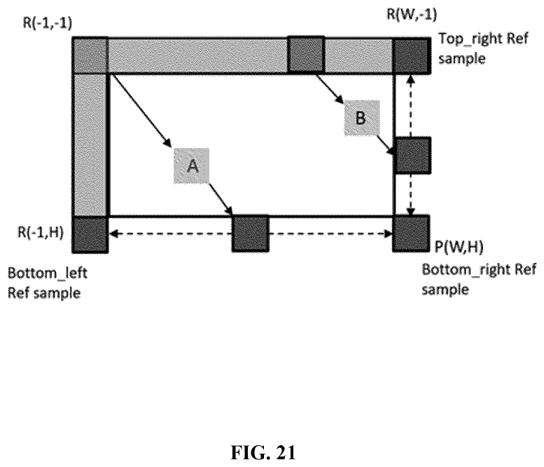

The bottom-left reference sample Rec(−1,H) and the estimated bottom-right sample Pred_br(x, y) may be used, for example, to linearly interpolate the samples at the bottom of the target block. The top-right reference sample Rec(W,−1) and the estimated bottom-right sample Pred_br(x, y) may be used, for example, to linearly interpolate the samples on the right of the target block. FIG. 21 illustrates an example linear interpolation for a current block. Using these samples, the predicted sample values can be linearly interpolated using a diagonal direction (e.g., as shown in FIG. 21).

The planar mode may provide predictions for image areas with smooth and gradually changing content, which may create neutral prediction blocks with no high frequency components for complex textures that may not be properly modeled with any of the directional predictors that the angular intra prediction may be able to generate. Some contents may have hybrid characteristics, for example, gradually changing along horizontal or vertical directions. Combining planar predictors and directional predictors could improve compression efficiency.

Additional planar vertical/horizontal modes (e.g., as described herein) may be used for such combinations. Improvements may be leveraged to further improve the compression efficiency and reduce the encoder searching complexity.

Interactions between planar vertical/horizontal modes and other coding tools may be leveraged (e.g., planar predictor used for DIMD blending). Rate-distortion optimizations (RDOs) (e.g., two additional RDOs) may be used in an encoder for deciding the planar vertical/horizontal modes. RDOs may (e.g., be expected to) provide a (e.g., significantly) better tradeoff, for example, further reducing encoder runtime while retaining or improving the compression. DIMD mode and gradients may be used, for example, to infer the directional mode. An RDO (e.g., additional RDO) may be (e.g., expected to) refrained from being used (e.g., may not be used) to check whether to use conventional planar mode or planar directional mode. The planar vertical/horizontal modes may be used (e.g., also be used) to decide the usage of other tools, for example, such as the reference region for TIMD/SGPM/chroma DIMD/CCCM.

Planar diagonal intra prediction (e.g., as described herein) and/or other possible planar directional modes may be used where there may be some interactions between them with the video coding tools.

Planar horizontal mode, planar vertical mode and planar directional mode may be performed. DIMD/ISP/MPM list/Chroma mode list may include the planar horizontal mode and planar vertical mode. Parameters (e.g., such as DIMD mode/gradients/block shape/neighboring intra modes/template) may be used to infer the planar horizontal mode or planar vertical mode. The planar horizontal mode and planar vertical mode may be used to choose the CCLM/MMLM mode, the reference region of TIMD/SGPM/chroma DIMD/CCCM or the split direction of ISP. Interactions between planar diagonal mode or planar directional mode with other coding tools may be done in a similar way described herein with respect to the planar horizontal mode and planar vertical mode. The (e.g., two) additional DC modes may be used, for example, such as DC horizontal and DC vertical.

DIMD may include blending with planar horizontal and/or planar vertical. For example, a DIMD mode may be derived. A directionality of a planar mode may be determined (e.g., conventional planar mode, planar horizontal mode, planar vertical mode) based on the determined DIMD mode. Based on the determined planar mode, a planar predictor for blending may be selected.

In examples (e.g., if DIMD is applied), two intra prediction modes may be derived from a HOG (e.g., IPM_{dimd_1st} and IPM_{dimd_2nd}), and may be combined (e.g., always combined) with the planar mode predictor DIMDₚₗₐₙₐᵣ.

Predictors (e.g., two predictors) DIMD₁ₛₜ and DIMD_{2nd} (e.g., generated with the two (e.g., best) intra prediction modes) may be combined with the planar horizontal DIMD_{planar_hor} and/or planar vertical DIMD_{planar_ver} mode predictor.

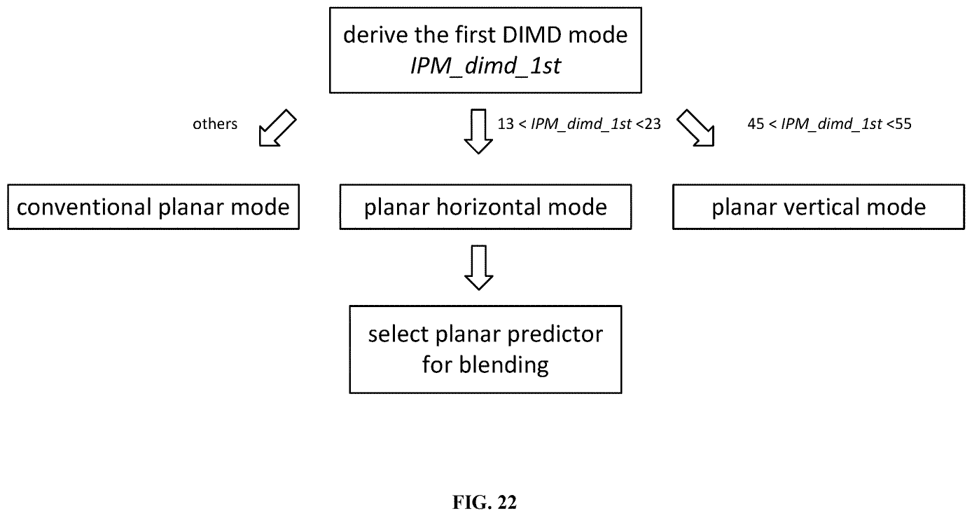

The choice for blending with the two (e.g., best) intra prediction modes among the (e.g., conventional) planar/planar horizontal/planar vertical mode may be inferred, for example, using the DIMD mode. FIG. 22 illustrates an example flow for determining blending for planar predictor modes. As illustrated in FIG. 22, the blending predictor combined with the two best intra prediction mode predictors for the current block is inferred as a horizontal planar mode predictor DIMD_{planar_hor}, for example, if the DIMD first mode IPM_{dimd_1st} is inside a (e.g., one) predefined mode range (e.g., meaning IPM_{dimd_1st} is greater than a (e.g., one) first predefined mode IPM₁ₛₜ and is less than a (e.g., one) second predefined mode IPM_{2nd}, such as mode range from 13 to 23). The blending predictor combined with the two (e.g., best) intra prediction mode predictors for the current block may be inferred as a vertical planar mode predictor DIMD_{planar_ver}, for example, if the DIMD first mode IPM_{dimd_1st} is inside another predefined mode range (e.g., IPM_{dimd_1st} is greater than a (e.g., one) third predefined mode IPM_{3rd} and is less than a (e.g., one) fourth predefined mode IPM₄ₜₕ, such as mode range from 45 to 55. The blending predictor combined with the two (e.g., best) intra prediction mode predictors for the current block may be inferred as a conventional planar mode predictor DIMDₚₗₐₙₐᵣ, for example, (e.g., otherwise) if the DIMD first mode IPM_{dimd_1st} is determined to be outside the predefined mode ranges (e.g., does not belong to any of these predefined mode ranges).

In examples, both the DIMD first mode IPM_{dimd_1st} and second mode IPM_{dimd_2nd} may be considered (e.g., taken into consideration) for choosing the blending predictor combined with the two (e.g., best) intra prediction mode predictors for the current block. The blending predictor combined with the two (e.g., best) intra prediction mode predictors for the current block may be inferred as a horizontal planar mode predictor DIMD_{planar_hor}, for example, if both DIMD first mode IPM_{dimd_1st} and second mode IPM_{dimd_2nd} are less than one first predefined mode IPM₁ₛₜ, such as mode 34 (e.g., IPM_{dimd_1st}<34 and IPM_{dimd_2nd}<34). The blending predictor combined with the two (e.g., best) intra prediction mode predictors for the current block may be inferred as a vertical planar mode predictor DIMD_{planar_ver}, for example, if both DIMD first mode IPM_{dimd_1st} and second mode IPM_{dimd_2nd} are greater than one second predefined mode IPM_{2nd}, such as mode 34 (e.g., IPM_{dimd_1st}>34 and IPM_{dimd_2nd}>34). The blending predictor combined with the two (e.g., best) intra prediction mode predictors for the current block may be inferred as a conventional planar mode predictor DIMDₚₗₐₙₐᵣ, for example, (e.g., otherwise) if DIMD first mode IPM_{dimd_1st} and second mode IPM_{dimd_2nd} are determined to meet none of the mentioned requirements.

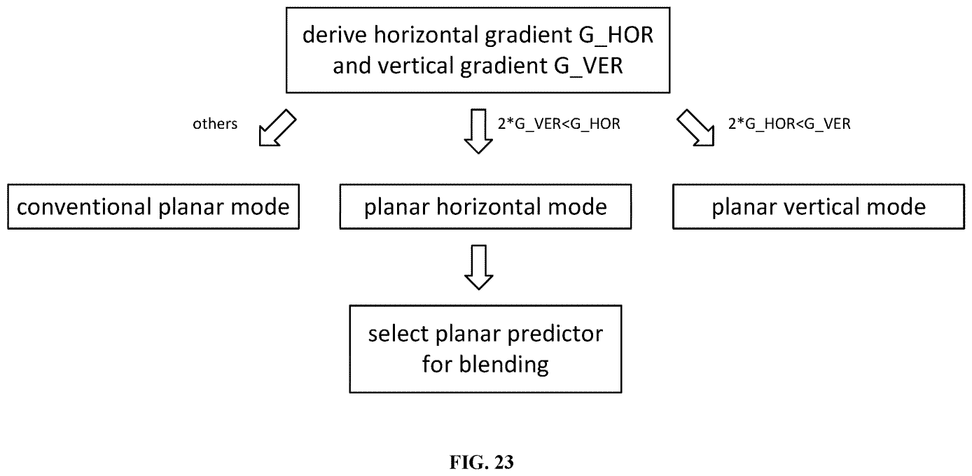

In examples, the choice for blending with the two (e.g., best) intra prediction modes among the (e.g., conventional) planar/planar horizontal/planar vertical may be inferred using the gradient. The horizontal gradient G_{HOR} and the vertical gradient G_{VER} for the (e.g., each) sample in the middle row or the middle column of the template of three rows of decoded reference samples above the current CU and three columns of decoded reference samples on its left side may be calculated using (a) filter(s) (e.g., given 3×3 horizontal Sobel filter and a 3×3 vertical Sobel filter respectively). The horizontal gradient G_{HOR} and the vertical gradient G_{HOR} may be (e.g., always) calculated (e.g., firstly) for the DIMD mode, for example, because these gradients may be considered (e.g., used) to derive the two (e.g., best) intra prediction modes. FIG. 23 illustrates an example flow of determining a planar predictor for blending. The gradient(s) may be used (e.g., directly reused) for deciding which planar predictor is selected to be combined with the two (e.g., best) intra prediction mode predictors (e.g., as illustrated in FIG. 23). The horizontal planar predictor DIMD_{planar_hor} may be used, for example, if the sum of the absolute values of the horizontal gradients is greater than the sum of the absolute values of the vertical gradients multiplied by one first predefined threshold TH₁ₛₜ, such as TH₁ₛₜ equals 2 (e.g., 2*G_{VER}<G_{HOR}). The vertical planar mode predictor DIMD_{planar_ver} may be used, for example, if the sum of the absolute values of the vertical gradients is greater than the sum of the absolute values of the horizontal gradients multiplied by one second predefined threshold TH_{2nd}, such as TH_{2nd} equals 2 (e.g., 2*G_{HOR}<G_{VER}). The blending predictor combined with the two (e.g., best) intra prediction mode predictors for the current block may be inferred as a conventional planar mode predictor DIMDₚₗₐₙₐᵣ, for example, (e.g., otherwise) if the sum of the absolute values of the horizontal gradients G_{HOR} and the sum of the absolute values of the vertical gradients G_{VER} are determined to meet none of the mentioned requirements.

The gradients used to select the conventional planar/planar horizontal/planar vertical mode predictor may (e.g., alternatively) be generated in a different way than those used to derive the two (e.g., best) intra prediction modes for DIMD. For example, the horizontal gradient G_{HOR} for the (e.g., each) sample in the middle row of a template of three rows of decoded reference samples above the current CU may be calculated using a given 3×3 horizontal Sobel filter, and the vertical gradient G_{VER} for the (e.g., each) sample in the middle column of a template of three columns of decoded reference samples on the left side of the current CU may be calculated using a given 3×3 vertical Sobel filter.

Conventional planar mode, planar horizontal mode, and planar vertical mode may be inferred. The planar intra-prediction mode (e.g., planar horizontal mode, planar vertical mode) may be determined (e.g., associated with or for a first coding block).

The DIMD mode and gradients may be used to infer the directional mode which indicates the usage of the planar horizontal mode and the planar vertical mode. To further reduce the signaling overhead and the searching complexity for the encoder, the planar mode may be inferred based on certain parameters, such as that (e.g., only) one among the conventional planar mode, planar horizontal mode and planar vertical mode may be tested and signaled for a (e.g., each) block. The DIMD mode may be used to infer the planar mode. The planar mode for the current block may be inferred as a horizontal planar mode PLANAR_{HOR}, for example, if the DIMD first mode IPM_{dimd_1st} is inside one predefined mode range (e.g., IPM_{dimd_1st} is greater than one first predefined mode IPM₁ₛₜ and is less than one second predefined mode IPM_{2nd}, such as mode range from 13 to 23). The planar mode for the current block may be inferred as a vertical planar mode PLANAR_{VER}, for example, if the DIMD first mode IPM_{dimd_1st} is inside another predefined mode range (e.g., IPM_{dimd_1st} is greater than one third predefined mode IPM_{3rd} and is less than one fourth predefined mode IPM₄ₜₕ, such as mode range from 45 to 55). The planar mode for the current block may be inferred as a conventional planar mode PLANAR_{ORI}, for example, (e.g., otherwise) if the DIMD first mode IPM_{dimd_1st} is determined to not belong (e.g., does not belong) to any of these predefined mode ranges. If (e.g., when) the MPM index is equal to 0, it may be a one-to-one mapping among PLANAR_{HOR}/PLANAR_{VER}/PLANAR_{ORI}.

In examples, the gradient may be used to infer the planar mode among the conventional planar mode, planar horizontal mode and planar vertical mode. The horizontal gradient G_{HOR} and the vertical gradient G_{VER} for the (e.g., each) sample in a template of decoded reference samples on above and left of the current CU may be calculated firstly for the DIMD mode, and may be used (e.g., directly reused) for deciding which planar mode is selected to be tested and signaled for the current block, the planar mode for the current block may be inferred as a horizontal planar mode PLANAR_{HOR}, for example, if the sum of the absolute values of the horizontal gradients is greater than the sum of the absolute values of the vertical gradients multiplied by one first predefined threshold TH₁ₛₜ, such as TH₁ₛₜ equals 2 (e.g., 2*G_{VER}<G_{HOR}). The planar mode for the current block may be inferred as a vertical planar mode PLANAR_{VER}, for example, if the sum of the absolute values of the vertical gradients is greater than the sum of the absolute values of the horizontal gradients multiplied by one second predefined threshold TH_{2nd}, such as TH_{2nd} equals to 2(e.g., 2*G_{HOR}<G_{VER}). The planar mode for the current block may be inferred as a conventional planar mode PLANAR_{ORI}, for example, (e.g., otherwise) if the sum of the absolute values of the horizontal gradients G_{HOR} and the sum of the absolute values of the vertical gradients G_{VER} are determined to meet none of the mentioned requirements.

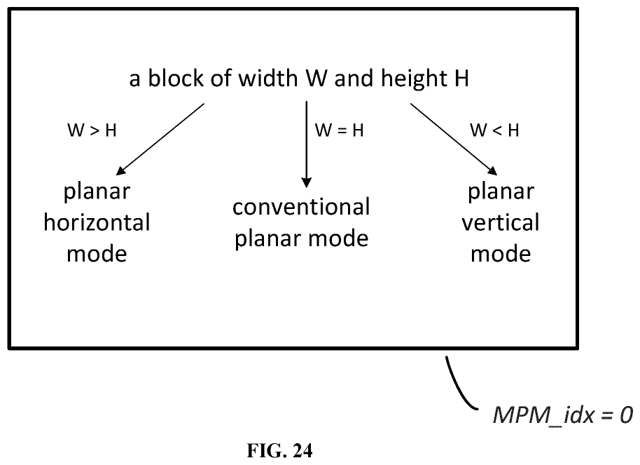

In examples, the block shape may be used to infer the planar mode among the conventional planar mode, planar horizontal mode and planar vertical mode. The block shape may be defined by the relationship between width W and height H of a block. FIG. 24 illustrates an example flow for determining a planar mode. As illustrated in FIG. 24, for horizontal-oriented blocks (W>H), the planar mode for the current block may be inferred as a horizontal planar mode PLANAR_{HOR}. For vertical-oriented blocks (W<H), the planar mode for the current block may be inferred as a vertical planar mode PLANAR_{VER}. The vertical planar mode may be inferred for horizontal-oriented blocks and the horizontal planar mode may be inferred for vertical-oriented blocks. Regarding the square blocks, the planar mode for the current block may be inferred as a conventional planar mode PLANAR_{ORI}. The aspect ratio of a block may be used, for example, rather than the simple comparison between W and H. The planar mode for the current block may be inferred as a horizontal planar mode PLANAR_{HOR}, for example, if the aspect ratio of a block is greater than one predefined threshold TH₁ₛₜ, such as TH₁ₛₜ equals to 4 (e.g., W/H>4). The planar mode for the current block may be inferred as a vertical planar mode PLANAR_{VER}, for example, if the aspect ratio of a block is smaller than one second predefined threshold TH_{2nd}, such as TH_{2nd} equals to ¼ (e.g., W/H<¼). The planar mode for the current block may be inferred as a conventional planar mode PLANAR_{ORI}, for example, (e.g., otherwise) if the aspect ratio of a block is determined to meet none of the mentioned requirements.

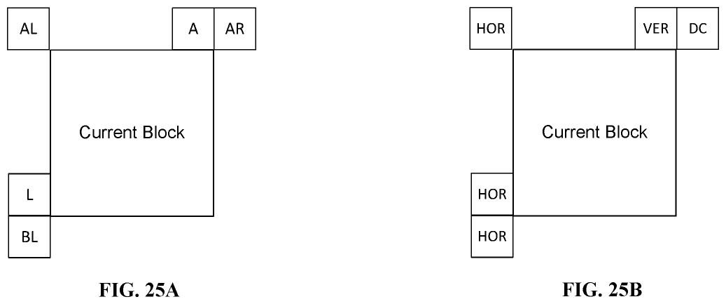

In examples, the neighboring intra modes may be used to infer the planar mode among the conventional planar mode, planar horizontal mode and planar vertical mode. For example, the intra modes of the above (A), left (L), below-left (BL), above-right (AR), and above-left (AL) neighboring blocks may be considered, whose locations are the same as those used for constructing the MPM list, as shown in FIG. 25A. FIGS. 25A and 25B illustrate an example current block with neighboring blocks. The corresponding planar mode for the current block may be inferred as a horizontal planar mode PLANAR_{HOR}, for example, if the (e.g., most of) neighboring intra modes are close to the horizontal direction. The corresponding planar mode for the current block may be inferred as a vertical planar mode PLANAR_{VER}, for example, if the (e.g., most of) neighboring intra modes are close to the vertical direction. The corresponding planar mode for the current block may be inferred as a conventional planar mode PLANAR_{ORI}, for example, if it is the same percentage of neighbouring intra modes close to the horizontal and the vertical direction. For example, as shown in FIG. 25B, the intra mode from L, BL, AL may be horizontal mode (e.g., HOR_IDX), and other two intra modes from A and from AR may be vertical mode (e.g., VER_IDX) and DC mode respectively. Therefore, the planar mode for the current block may be inferred as a horizontal planar mode PLANAR_{HOR}.

In examples, the corresponding planar mode for the current block may be inferred as a horizontal planar mode PLANAR_{HOR}, for example, if the (e.g., most of) left neighboring intra modes (e.g., such as the intra modes from L, BL, AL) are close to the horizontal direction. The corresponding planar mode for the current block may be inferred as a vertical planar mode PLANAR_{VER}, for example, if most of above neighboring intra modes (e.g., such as the intra modes from A, AR, AL) are close to the vertical direction. Intra modes of more (e.g., or less) spatial neighboring blocks, or some spatial neighboring blocks with different locations from those used for constructing the MPM list, may be considered.

In examples, a template may be used to infer the planar mode among the conventional planar mode, planar horizontal mode and planar vertical mode. For the (e.g., each) planar mode, the SATD between the prediction and reconstruction samples of a template may be calculated. For a block of size W×H, the template may comprise left already reconstructed samples of size L1×H and above already reconstructed samples of size W×L2, respectively (e.g., similar to TIMD/SGPM). The prediction of the template may be obtained for the (e.g., each) planar mode from the reference samples located in the reference of the template. The planar mode with the minimum SATD may be selected as the intra prediction mode candidate for this block. Different reference regions for the template may be used, for example, such as using the whole neighboring left/above block.

In examples, some (e.g., all) of these parameters (e.g., as described herein) may be combined to infer the planar mode among the conventional planar mode, planar horizontal mode and planar vertical mode.

Planar horizontal and planar vertical may be identified as independent intra modes distinct from conventional planar mode.

A syntax element may be further signaled (e.g., by truncated unary code), for example, to indicate whether the current block is the conventional planar or directional planar prediction and/or specify the direction information (e.g., horizontal or vertical planar mode), for example, if (e.g., when) planar horizontal and planar vertical intra prediction modes are applied, if the planar indication (e.g., flag) indicates that a planar mode is used for the current block (e.g., when the MPM index is equal to 0), and/or the current block is a non-ISP coded luma block.

The propagated modes of the horizontal planar mode and vertical planar mode may be (e.g., always) considered as planar mode, for example, if (e.g., when) obtaining the MPM entries from the intra modes of the neighboring blocks, which might not fully take advantage of the high correlation between the current block and its neighboring blocks.

Horizontal planar mode and vertical planar mode may be included as candidates to construct the MPM list, for example, if they happen to be the intra modes of the spatial neighboring blocks. It may be determined to include horizontal planar mode and/or vertical planar mode as a candidate to construct the MPM list. The MPM list may be determined based on the directionality of the planar mode. Horizontal planar mode and/or vertical planar mode may be independent from conventional planar mode (e.g., as candidates to construct the MPM list). For example, the horizontal planar mode and vertical planar mode may be included in the MPM list as their associated directional modes, if they are the intra modes of the spatial neighboring blocks. The horizontal planar mode may be thus considered as horizontal mode (e.g., HOR_IDX), and the vertical planar mode may be considered as vertical mode (e.g., VER_IDX) respectively.

Horizontal planar mode and vertical planar mode may be signaled as (e.g., new) independent intra modes distinct from other intra modes, for example, rather than treating the horizontal planar mode and vertical planar mode as conventional planar mode or associated directional modes. Besides the existing 67 intra prediction modes (e.g., index 0-65), the vertical planar mode may be indexed as PLANAR_VER_IDX (e.g., index=66) and the horizontal planar mode may be indexed as PLANAR_HOR_IDX (e.g., index=67). A (e.g., general) MPM list (e.g., with 22 entries) may be kept, and a primary MPM (PMPM) list may be (e.g., always) filled (e.g., with 6 entries), for example, where the first entry of PMPM may be the conventional Planar mode. With the two additional modes, the remaining entries of MPM list may be constructed by one or more of the following examples.

For example, the two additional vertical planar and horizontal planar modes may be directly inserted after the conventional Planar mode, for example, if (e.g., when) the MPM index is equal to 1, and the intra prediction mode of the current block is vertical planar mode PLANAR_VER_IDX (e.g., index=66); or if (e.g., when) the MPM index is equal to 2, and the intra prediction mode of the current block is horizontal planar mode PLANAR_HOR_IDX (e.g., index=67). The remaining entries may be obtained from the intra modes of the above (A), left (L), below-left (BL), above-right (AR), and above-left (AL) neighboring blocks in order. If the PMPM list is already full, some of those spatial neighboring intra prediction modes candidates could be used to fill the secondary MPM (SMPM).

For example, the remaining entries may be obtained from the spatial neighboring blocks in order. The two additional vertical planar and horizontal planar modes could be inserted to the PMPM list, for example, if there are some empty entries after adding those spatial neighboring intra prediction modes candidates.

The two additional vertical planar and horizontal planar modes may be included in the predefined default modes. For example, they could be inserted after the DC mode: {DC_IDX, PLANAR_VER_IDX, PLANAR_HOR_IDX, VER_IDX, HOR_IDX, VER_IDX−4, VER_IDX+4, 14, 22, 42, 58, 10, 26, 38, 62, 6, 30, 34, 66, 2, 48, 52, 16}.

The two additional vertical planar and horizontal planar modes could be inserted in (e.g., any) other positions in the MPM list. The remaining non-MPM modes may be 47 (e.g., instead of 45), and the index non_mpm_index may be signaled (e.g., using truncated binary code with 5 to 6 bits). For these two additional vertical planar and horizontal planar mode, similar to planar mode, there may be no related derived modes with added offset (e.g., ±1,±2,±3,±4). Remaining part of the existing MPM list construction may be kept.

In examples, the number of general MPM list entries, and/or PMPM list entries, and/or SMPM list entries may be adapted with the two additional vertical planar and horizontal planar modes.

In examples, if mrl_index is determined to not be 0, the two additional vertical planar and horizontal planar modes may be excluded as the entries for constructing the MPM list.

Planar horizontal and planar vertical may be enabled for chroma mode coding.

The intra prediction modes enabled for the chroma components may include the planar, horizontal and vertical modes (e.g., HOR_IDX, VER_IDX), DC, CCLM modes (e.g., CCLM_LT, CCLM_L and CCLM_T), MMLM modes (e.g., MMLM_LT, MMLM_L and MMLM_T), DIMD, and/or direct mode (DM) from collocated luma block.

Horizontal planar mode and vertical planar mode may be enabled for the chroma components. For example, if (e.g., when) planar horizontal and planar vertical intra prediction modes are applied for chroma blocks, and/or if the planar flag indicates that a planar mode is used for the current chroma block, a syntax element may be signaled (e.g., by truncated unary code) to indicate whether the current chroma block is the conventional planar or directional planar prediction and/or specify the direction information (e.g., horizontal or vertical planar mode).

In examples, certain parameters could be used to infer the planar directional mode, for example, which may indicate the usage of the planar horizontal mode and the planar vertical mode for a chroma block (e.g., such as using the chroma DIMD mode). For example, if the current chroma block is a planar predicted but not a conventional planar mode, the current chroma block may be inferred as a horizontal planar mode, for example, if chroma DIMD first mode is less than the mode 34 (e.g., IPM_{dimd_chroma_1st}<34). The current chroma block may be inferred as a vertical planar mode, for example (e.g., otherwise), if the chroma DIMD first mode is equal to or greater than the mode 34 (e.g., IPM_{dimd_chroma_1st}≥34). In examples, the direct mode (DM) from collocated luma block may be used, for example, if the current chroma block is a planar predicted but not a conventional planar mode, and the DM is less than the mode 34 (e.g., IPM_{dm}<34), then the current chroma block may be inferred as a horizontal planar mode. The current chroma block may be inferred as a vertical planar mode, for example, (e.g., otherwise) if the DM is equal to or greater than the mode 34 (e.g., IPM_{dm}≥34). Other parameters, such as gradients/block shape/neighboring intra modes, could also be considered.

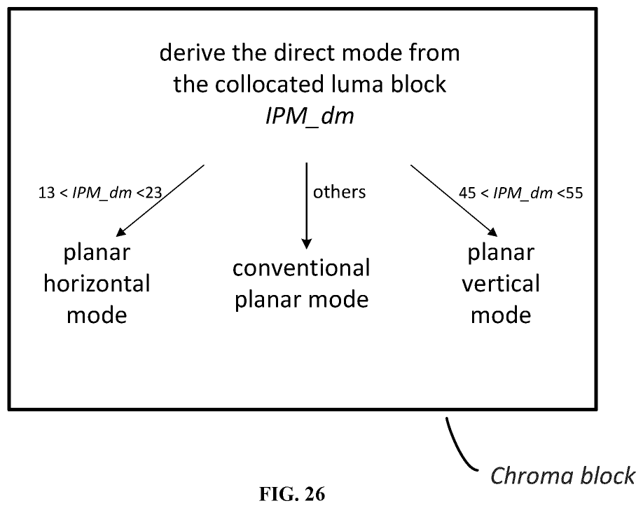

In examples, certain parameters (e.g., such as using the chroma DIMD mode) could be used to infer the planar mode, which may indicate the usage of the conventional planar mode, the planar horizontal mode and the planar vertical mode for a chroma block. The decision process could be the same as described herein with respect to inferring conventional planar mode, planar horizontal mode, and planar vertical mode using the DIMD mode for a luma block. In examples, the direct mode (DM) from collocated luma block may be used. FIG. 26 illustrates an example flow for determining planar mode. As illustrated in FIG. 26, the planar mode for the current chroma block may be inferred as a horizontal planar mode PLANAR_{HOR}, for example, if the DM mode IPM_{dm} is inside a (e.g., one) predefined mode range (e.g., IPM_{dm} is greater than a (e.g., one) first predefined mode IPM₁ₛₜ and is less than a (e.g., one) second predefined mode IPM_{2nd}, such as mode range from 13 to 23). The planar mode for the current chroma block may be inferred as a vertical planar mode PLANAR_{VER}, for example, if the DM mode IPM_{dm} is inside another predefined mode range (e.g., IPM_{dm} is greater than a (e.g., one) third predefined mode IPM_{3rd} and is less than a (e.g., one) fourth predefined mode IPM₄ₜₕ, such as mode range from 45 to 55)). The planar mode for the current chroma block may be inferred as a conventional planar mode PLANAR_{ORI}, for example, (e.g., otherwise) if the DM mode IPM_{dm} is determined to not belong to any of these predefined mode ranges. Other parameters, such as gradients/block shape/neighboring intra modes, could also be considered.

In examples, horizontal planar mode and vertical planar mode may be signaled as (e.g., new) independent intra modes distinct from conventional planar mode, for example, if (e.g., when) they are enabled for the chroma components. The two planar modes may be included (e.g., in addition to the existing 12 chroma intra prediction modes) into the chroma mode list: the vertical planar mode (e.g., PLANAR_VER_IDX) and the horizontal planar mode (e.g., PLANAR_HOR_IDX). The two additional vertical planar and horizontal planar modes may be directly inserted (e.g., when constructing the chroma mode list) after the conventional Planar mode.

The CCLM/MMLM mode or the reference region of chroma DIMD/CCCM may be chosen for a chroma block, for example, based on the planar mode from the collocated luma block. For example, reconstructed neighboring samples may be identified based on the determined planar intra-prediction mode. For example, reconstructed neighboring samples may be associated with a left boundary of a coding block if the planar intra-prediction mode is horizontal planar mode. The reconstructed neighboring samples may be associated with a top boundary of a coding block if the planar intra-prediction mode is vertical planar more. The reconstructed neighboring samples may be associated with both a top boundary and a left boundary of a coding block if the planar intra-prediction mode is conventional planar mode. A decoding function and/or encoding function may be performed based on the determined reconstructed neighboring samples. If a decoding/encoding function is associated with a chroma block, the reconstructed neighboring samples may be a luma block (e.g., collocated luma block). If a decoding/encoding function is associated with a luma block (e.g., first block), the reconstructed neighboring samples may be from a neighboring block (e.g., second block)

CCLM modes (e.g., CCLM_LT, CCLM_L and CCLM_T) and MMLM modes (e.g., MMLM_LT, MMLM_L and MMLM_T) may be enabled for the chroma components. Those CCLM/MMLM modes may differ with respect to the locations of the reference samples that are used for model parameter derivation. Samples from the top boundary may be involved in the CCLM_T/MMLM_T mode and samples from the left boundary may be involved in the CCLM_L/MMLM_L mode. In the CCLM_LT/MMLM_LT mode, samples from both the top boundary and the left boundary may be used. The signaling overhead and the searching complexity for the encoder may be reduced for a chroma block, for example, if the possible cross-component models could be limited or inferred.

The prediction characteristics of a chroma block may be similar to the prediction characteristics of its collocated luma block. The CCLM/MMLM mode for a chroma block many be chosen, for example, based on the planar mode from the collocated luma block. In examples (e.g., for a chroma block), CCLM_L and/or MMLM_L (e.g., only CCLM_L and MMLM_L) modes may be tested and signaled as the cross-component models for the current chroma block, for example, if its collocated luma block is a planar predicted using planar horizontal mode. CCLM_T and MMLM_T (e.g., only CCLM_T and MMLM_T) modes may be tested and signaled as the cross-component models for the current chroma block, for example, if its collocated luma block is predicted with planar vertical mode. The reverse case may be used, for example, that CCLM_L and MMLM_L modes may be tested for the chroma block if the vertical planar mode is used for its collocated luma block, and CCLM_T and MMLM_T modes may be tested for the chroma block if the horizontal planar mode is used for its collocated luma block. The CCLM and MMLM modes (e.g., all three CCLM modes and three MMLM modes) may be tested and signaled as the cross-component models for the current chroma block, for example, (e.g., otherwise) if its collocated luma block is a planar predicted with a conventional planar mode.

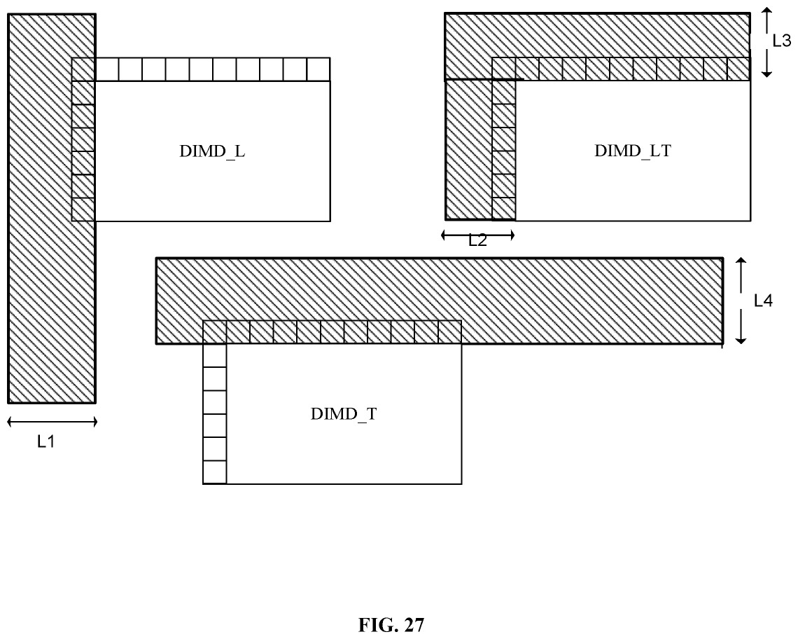

In examples, the reference region used for chroma DIMD for a chroma block may be chosen, for example, based on the planar mode from the collocated luma block. In chroma DIMD, the intra prediction mode for chroma block may be derived by using previously reconstructed neighboring pixels through a gradient analysis. The reference region used in chroma DIMD may be fixed as left, top and top-left neighborhoods (e.g., as illustrated in FIG. 10). Different neighborhoods (e.g., reference regions) may be used for chroma DIMD, which are represented by DIMD_T and DIMD_L in FIG. 27. FIG. 27 illustrates an example of using chroma DIMD. DIMD_T may represent using top-left, top, and top-right neighborhoods as a reference region, and DIMD_L may represent using top-left, left, and left-bottom neighborhoods as a reference region. The original reference region used for chroma DIMD mode may be referred to as DIMD_LT. For a chroma block, if its collocated luma block is a planar predicted but not a conventional planar mode, such as using planar horizontal mode, then the reference region represented by DIMD_L may be used for deriving the DIMD mode for the current chroma block. The reference region represented by DIMD_T may be used for deriving the DIMD mode for the current chroma block, for example, if its collocated luma block is predicted with planar vertical mode. The reverse case may be used, for example, that the reference region represented by DIMD_L may be used for deriving the chroma DIMD mode of a chroma block if the vertical planar mode is used for its collocated luma block, and the reference region represented by DIMD_T may be used for deriving the chroma DIMD mode of a chroma block if the horizontal planar mode is used for its collocated luma block. The original reference region represented by DIMD_LT may be used for deriving the chroma DIMD mode of the current chroma block.

In examples, the reference region used for CCCM for a chroma block may be chosen based on the planar mode from the collocated luma block. Different neighborhoods (e.g., reference regions) may be chosen for CCCM, for example, if (e.g., when) calculating the filter coefficients based on the planar mode from the collocated luma block (e.g., similar to the selection process of the reference region for chroma DIMD as described herein).

The reference region/template of TIMD/SGPM may be chosen based on the planar mode.

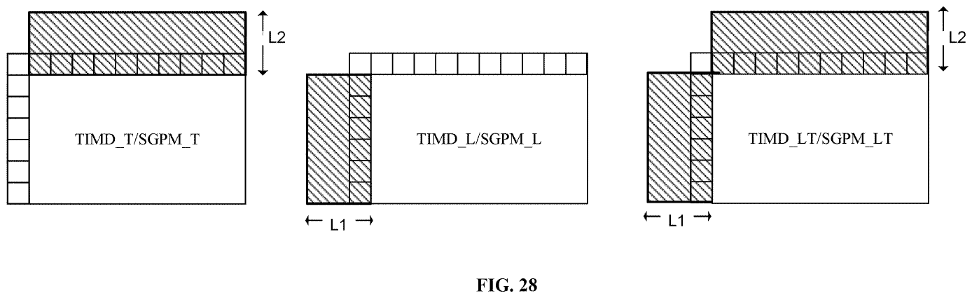

The reference region/template used for TIMD/SGPM for a luma block may be chosen based on the planar mode. In TIMD and SGPM, a template comprising left already reconstructed samples of size L1×H and above already reconstructed samples of size W×L2, may be used to derive the intra prediction mode for the block or the SGPM candidate list. The reference region used in TIMD/SGPM may be fixed. Different neighborhoods (e.g., reference regions) for TIMD/SGPM may be used, for example, which are represented by TIMD_T/SGPM_T and TIMD_L/SGPM_L in FIG. 28. FIG. 28 illustrates an example of using different reference regions for TIMD/SGPM. TIMD_T/SGPM_T may represent using top neighborhoods as a reference region, and TIMD_L/SGPM_L may represent using left neighborhoods as a reference region. The original reference region used for TIMD/SGPM mode may be referred as TIMD_LT/SGPM_LT. For a luma block using TIMD or SGPM mode, if a planar horizontal mode is selected for current block or subpart of the current block, the reference region represented by TIMD_L/SGPM_L may be used for calculating the SATD cost for this intra prediction mode or this SGPM candidate. The reference region represented by TIMD_T/SGPM_T may be used for calculating the SATD cost for this intra prediction mode or this SGPM candidate, for example, if a planar vertical mode is selected for current block or subpart of the current block. The reverse case may be used. The original reference region represented by TIMD_LT/SGPM_LT may be used for calculating the SATD cost for this intra prediction mode or this SGPM candidate, for example, (e.g., otherwise) if a conventional planar mode is selected for current block.

There may be interaction between planar horizontal and planar vertical with other intra tools.

Reference sample smoothing may be applied for planar mode (e.g., as described herein). This pre-processing may improve visual appearance of the prediction block, for example, by avoiding steps in the values of reference samples that could potentially generate unwanted directional edges to the prediction block. Reference sample smoothing may be refrained from being applied (e.g., no reference sample smoothing is applied) for planar horizontal mode/planar vertical mode, which might not be the optimal usage of the smoothing filter on these two modes. Reference sample smoothing for planar horizontal mode/planar vertical mode may be applied (e.g., similar to as what is done for planar mode), for example, for a given luma block with some constraints (e.g., such as the block size), a reference sample filter may be applied to reference samples to further copy these filtered values into a planar horizontal/planar vertical predictor according to the selected direction (e.g., horizontal or vertical), but interpolation filters may be refrained from being applied (e.g., no interpolation filters are applied).

PDPC may include a post-processing step (e.g., as described herein) after prediction to refine the sample surface continuity on the block boundaries, for example, which may combine the intra prediction block samples with unfiltered or filtered boundary reference samples by employing intra mode and position dependent weighting. PDPC may be applied for planar horizontal mode/planar vertical mode as done for planar mode. PDPC for planar horizontal mode/planar vertical mode may be applied (e.g., similar to as what is done for horizontal/vertical mode), for example, because a block after performing prediction might have the similar characteristics to the horizontal and vertical direction mode.

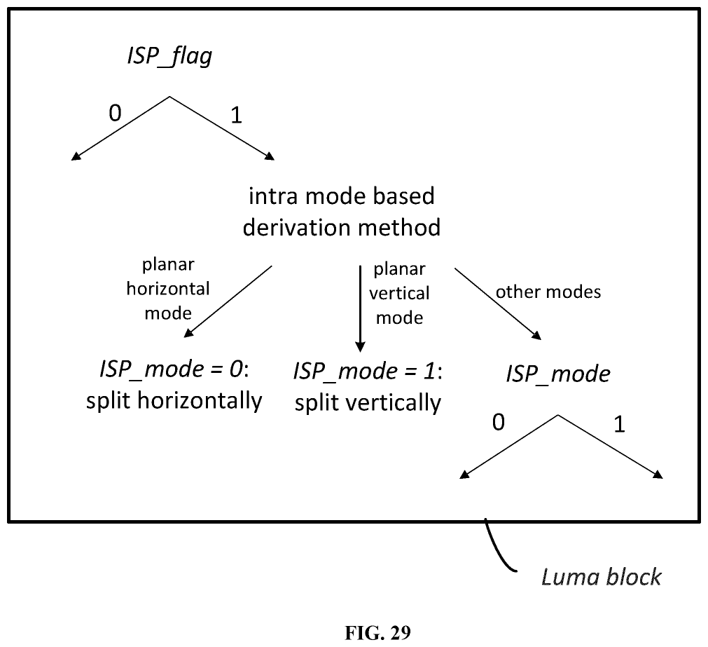

Additional planar horizontal mode/planar vertical mode may be applied (e.g., only be applied) to a luma block, for example, without using ISP. ISP may be performed and/or determined based on a directionality of a planar mode (e.g., based on whether the directionality is horizontal planar mode, vertical planar mode). Planar horizontal mode/planar vertical mode may be applied for an ISP coded luma block, because the conventional planar mode had no design/implementation issue to be used for an ISP block. Split direction of ISP may be determined based on a directionality of a planar mode. In examples, the split direction of ISP could be inferred from the planar horizontal/vertical mode, for example, if an ISP coded luma block is a planar predicted but not a conventional planar mode. Syntax (e.g., isp_mode) to specify the split vertically or horizontally may be inferred from the planar horizontal/vertical. FIG. 29 illustrates an example flow for applying planar modes to a luma block. As shown in FIG. 29, if an ISP coded luma block is predicted with a planar horizontal mode (PLANAR_{HOR}), then this luma block may be divided horizontally into 2 or 4 sub-partitions (e.g., isp_mode is inferred as 0 to specify the split horizontally). If a planar vertical mode (PLANAR_{VER}) is selected for an ISP coded luma block, this luma block may be divided vertically into 2 or 4 sub-partitions (e.g., meaning isp_mode is inferred as 1 to specify the split vertically). The reverse case may be used.

There may be interaction between planar diagonal or planar directional with the other video coding tools.

Reference sample smoothing/PDPC for planar diagonal (or directional) mode may be applied (e.g., similarly as what is done for planar mode or diagonal or related directional modes).

Parameters (e.g., DIMD mode/gradients/block shape/neighboring intra modes/template) may be used to infer the planar directional mode.

DIMD may include blending with planar diagonal DIMD_{planar_diag} or directional predictor DIMD_{planar_dir}.

Planar diagonal or directional mode may be included in the construction of the MPM list or the chroma mode list.

Planar diagonal or directional mode may be used to choose the CCLM/MMLM mode or the reference region of TIMD/SGPM/chroma DIMD/CCCM.

The residual characteristics of the planar diagonal mode may be similar to the residual characteristics of the diagonal or other direction mode. The transform kernel mapping for the planar diagonal or directional mode may include using a planar diagonal or directional mode to derive a transform kernel in multiple transform selection (MTS) set and low-frequency non-separable transform (LFNST). The diagonal intra prediction mode or related directional intra prediction mode may be used to derive a transform kernel in MTS set and LFNST set, for example, if an intra prediction mode of a current block is the planar diagonal or directional mode.

DC horizontal and DC vertical modes may be used (e.g., determined to be used). The DC mode may be determined based on a directionality of a planar mode (e.g., DC horizontal mode determined based on horizontal planar mode, DC vertical mode determined based on vertical planar mode).

Two additional DC modes may be used: DC horizontal and DC vertical. For DC horizontal mode, the average may be (e.g., only) performed based on the left reference sample in accordance with Eq. 13.

$$Pred ( x , y ) = \frac{{\sum }_{x = 0}^{H - 1} Rec ( - 1 , y )}{H} \qquad Eq . 13$$

For DC vertical mode, the average may be (e.g., only) performed based on the above reference sample in accordance with Eq. 14.

$$Pred ( x , y ) = \frac{{\sum }_{x = 0}^{W - 1} Rec ( x , - 1 )}{W} \qquad Eq . 14$$

The block's propagation mode may be set to the original DC mode, or horizontal/vertical mode, for example, if (e.g., when) the current block enables one of the two proposed DC modes.

For signaling (e.g., if the DC is used for the current block), a syntax element may be signaled (e.g., by truncated unary code) to indicate which of the conventional DC mode, the DC horizontal mode and the DC vertical mode is selected to predict the current block.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1-40. (canceled)

41. A video decoding method comprising:
determining a planar intra-prediction mode associated with a first coding block;
identifying a plurality of reconstructed neighboring samples based on the determined planar intra-prediction mode; and
performing a decoding function on a second coding block based on the identified plurality of reconstructed neighboring samples.

42. The video decoding method of claim 41, wherein the planar intra-prediction mode associated with the first coding block is determined to be one of a horizontal planar mode, a vertical planar mode, or a conventional planar mode.

43. The video decoding method of claim 41, wherein:
based on a determination that the planar intra-prediction mode is horizontal planar mode, the plurality of reconstructed neighboring samples associated with a left boundary of the second coding block are identified,
based on a determination that the planar intra-prediction mode is vertical planar mode, the plurality of reconstructed neighboring samples associated with a top boundary of the second coding block are identified, and
based on a determination that the planar intra-prediction mode is conventional planar mode, the plurality of reconstructed neighboring samples associated with the top boundary and the left boundary of the second coding block are identified.

44. The video decoding method of claim 41, wherein the first coding block is a luma block, wherein the second coding block is a chroma block collocated with the luma block, wherein the decoding function comprises cross component chroma prediction, and wherein the method further comprises:
determining, based on the plurality of reconstructed neighboring samples that are identified based on the planar intra-prediction mode of the luma block, a cross component chroma prediction mode associated with the chroma block, wherein the cross component chroma prediction mode using the plurality of reconstructed neighboring samples is one of a cross component linear model (CCLM) prediction, a multi-model linear model (MMLM) prediction, or a convolutional cross-component model (CCCM) prediction.

45. The video decoding method of claim 44, wherein the CCLM prediction is associated with one of a left boundary reference sample CCLM mode, a top boundary reference sample CCLM mode, or a left and top boundary reference sample CCLM mode, and wherein the MMLM prediction is associated with a left boundary reference sample MMLM mode, a top boundary reference sample MMLM mode, or a left and top boundary reference sample MMLM mode.

46. The video decoding method of claim 41, wherein the first coding block is a neighbor block of the second coding block.

47. The video decoding method of claim 41, wherein the first coding block is a reference coding block, wherein the second coding block is a current coding block, and wherein the method further comprises:
deriving, based on the plurality of reconstructed neighboring samples identified using the planar intra-prediction mode of the reference coding block, a prediction mode associated with the current coding block, wherein the prediction mode is derived using at least one of a template-based intra mode derivation (TIMD), a spatial geometric partitioning mode (SGPM), or a decoder-side intra mode derivation (DIMD).

48. A video encoding method for using a first coding block to encode a second coding block comprising:
determining a planar intra-prediction mode to encode the second coding block;
identifying a plurality of reconstructed neighboring samples associated with the first coding block based on the determined planar intra-prediction mode;
performing an encoding function on the second coding block based on the identified plurality of reconstructed neighboring samples associated with the first coding block; and
generating video data comprising intra-prediction mode information indicating the planar intra-prediction mode.

49. The video encoding method of claim 48, wherein the planar intra-prediction mode associated with the first coding block is determined to be one of a horizontal planar mode, a vertical planar mode, or a conventional planar mode.

50. The video encoding method of claim 48, wherein:
based on a determination that the planar intra-prediction mode is horizontal planar mode, the plurality of reconstructed neighboring samples associated with a left boundary of the second coding block are identified,
based on a determination that the planar intra-prediction mode is vertical planar mode, the plurality of reconstructed neighboring samples associated with a top boundary of the second coding block are identified, and
based on a determination that the planar intra-prediction mode is conventional planar mode, the plurality of reconstructed neighboring samples associated with the top boundary and the left boundary of the second coding block are identified.

51. The video encoding method of claim 48, wherein the first coding block is a luma block, wherein the second coding block is a chroma block collocated with the luma block, wherein the encoding function comprises cross component chroma prediction, and wherein the method further comprises:
determining, based on the plurality of reconstructed neighboring samples that are identified based on the planar intra-prediction mode of the luma block, a cross component chroma prediction mode associated with the chroma block, wherein the cross component chroma prediction mode using the plurality of reconstructed neighboring samples is one of a linear model (CCLM) prediction, multi-model linear model (MMLM) prediction, or a convolutional cross-component model (CCCM) prediction.

52. The video encoding method of claim 11, wherein the CCLM prediction is associated with one of a left boundary reference sample CCLM mode, a top boundary reference sample CCLM mode, or a left and top boundary reference sample CCLM mode, and wherein the MMLM prediction is associated with a left boundary reference sample MMLM mode, a top boundary reference sample MMLM mode, or a left and top boundary reference sample MMLM mode.

53. The video encoding method of claim 48, wherein the second coding block is a neighbor of the first coding block.

54. The video encoding method of claim 48, wherein the first coding block is a reference coding block, the second coding block is a current coding block, and the method further comprises:
deriving, based on the plurality of reconstructed neighboring samples identified using the planar intra-prediction mode of the reference coding block, a prediction mode associated with the current coding block, wherein the prediction mode using the plurality of reconstructed neighboring samples uses one of a template-based intra mode derivation (TIMD), a spatial geometric partitioning mode (SGPM), or a decoder-side intra mode derivation (DIMD).

55. A video decoding device comprising:
a processor configured to:
determine a planar intra-prediction mode associated with a first coding block;
identify a plurality of reconstructed neighboring samples based on the determined planar intra-prediction mode; and
perform a decoding function on a second coding block based on the identified plurality of reconstructed neighboring samples.

56. The video decoding device of claim 55, wherein the planar intra-prediction mode associated with the first coding block is determined to be one of a horizontal planar mode, a vertical planar mode, or a conventional planar mode.

57. The video decoding device of claim 55, wherein:
based on a determination that the planar intra-prediction mode is horizontal planar mode, the plurality of reconstructed neighboring samples associated with a left boundary of the second coding block are identified,
based on a determination that the planar intra-prediction mode is vertical planar mode, the plurality of reconstructed neighboring samples associated with a top boundary of the second coding block are identified, and
based on a determination that the planar intra-prediction mode is conventional planar mode, the plurality of reconstructed neighboring samples associated with the top boundary and the left boundary of the second coding block are identified.

58. The video decoding device of claim 55, wherein the first coding block is a luma block, wherein the second coding block is a chroma block collocated with the luma block, wherein the decoding function comprises cross component chroma prediction, and wherein the processor is further configured to:
determine, based on the plurality of reconstructed neighboring samples that are identified based on the planar intra-prediction mode of the luma block, a cross component chroma prediction mode associated with the chroma block, wherein the cross component chroma prediction mode using the plurality of reconstructed neighboring samples is one of a linear model (CCLM) prediction, multi-model linear model (MMLM) prediction, or a convolutional cross-component model (CCCM) prediction, wherein the CCLM prediction is associated with one of a left boundary reference sample CCLM mode, a top boundary reference sample CCLM mode, or a left and top boundary reference sample CCLM mode, and wherein the MMLM prediction is associated with a left boundary reference sample MMLM mode, a top boundary reference sample MMLM mode, or a left and top boundary reference sample MMLM mode.

59. The video decoding device of claim 55, wherein the first coding block is a neighbor block of the second coding block.

60. The video decoding device of claim 55, wherein the first coding block is a reference coding block, the second coding block is a current coding block, and the processor is further configured to:
derive, based on the plurality of reconstructed neighboring samples identified using the planar intra-prediction mode of the reference coding block, a prediction mode associated with the current coding block wherein the prediction mode is derived using at least one of a template-based intra mode derivation (TIMD), a spatial geometric partitioning mode (SGPM), or a decoder-side intra mode derivation (DIMD).
